(19) United States
(12) Patent Application Publication
(10) Pub. No.: US 2020/0142117 A1
(43) Pub. Date: May 7, 2020

(54) OPTICAL DEVICE AND LAMINATED FILM

(71) Applicant: FUJIFILM Corporation, Tokyo (JP)

(72) Inventor: Yujiro YANAI, Minami-Ashigara-shi (JP)

(73) Assignee: FUJIFILM Corporation, Tokyo (JP)

(21) Appl. No.: 16/723,322

(22) Filed: Dec. 20, 2019

Related U.S. Application Data
(63) Continuation of application No. PCT/JP2018/022399, filed on Jun. 12, 2018.

(30) Foreign Application Priority Data
Jun. 22, 2017 (JP) 2017-121899

(51) Int. Cl. G02B 5/30; G01J 5/08

(52) U.S. Cl. CPC G02B 5/3016; G01J 5/0809; G01J 5/0896

(57) ABSTRACT

An object of the present invention is to provide an optical device used in motion capture and the like that detects the motion of a person and the like and can detect a person and the like while observing the background, and a laminated film used in the optical device. The object is achieved by an optical device including an infrared light source, an infrared sensor, and a reflection member, in which infrared radiated from the light source is reflected from the reflection member, the reflected infrared is detected by the infrared sensor, and the reflection member is obtained by fixing cholesteric liquid crystalline phases reflecting infrared and has a plurality of regions in which helical axes incline in different directions, and a laminated film including a layer, in which bright portions and dark portions resulting from cholesteric liquid crystalline phases have a lenticular structure, and an array obtained by two-dimensionally arranging dots obtained by fixing cholesteric liquid crystalline phases.

### CROSS-REFERENCE TO RELATED APPLICATIONS

This application is a Continuation of PCT International Application No. PCT/JP2018/022399 filed on Jun. 12, 2018, which claims priority under 35 U.S.C. § 119(a) to Japanese Patent Application No. 2017-121899 filed on Jun. 22, 2017. The above application is hereby expressly incorporated by reference, in its entirety, into the present application.

### BACKGROUND OF THE INVENTION

### 1. Field of the Invention

The present invention relates to an optical device used for motion capture and the like and a laminated film used in the optical device.

### 2. Description of the Related Art

In recent years, in the field of information processing devices, the field of so-called shape recognition or motion capture has become widespread which is a process of detecting and recognizing the shape and motion of a person's hand by using an infrared light source, an infrared camera, and the like and performing image analysis, image processing, and the like based on the results of recognition and the like.

In a case where there are a person, an article, and the like, a device performing motion capture also plays a role of depth sensor that recognizes the distance between the device and the person, the article, and the like.

For example, US2010/0118123A describes a depth mapping device which projects infrared through microlens on an object as a pattern of a number of bright spots, detects infrared reflected from the object, detects the depth of the object based on a change in shape, brightness, and the like of the pattern of bright spots, and performs mapping of the depth of the object.

Furthermore, JP2010-169405A describes, as the principle of a so-called time-of-flight optical distance sensor, an operation of calculating the distance between the sensor and an object of distance measurement based on a phase difference between blinking infrared and light reflected from the object of distance measurement.

Specifically, JP2010-169405A describes a process of irradiating the object of distance measurement with infrared as blinking light according to light emission signals, generating light receiving signals by receiving the infrared reflected from the object of distance measurement, determining a phase difference, that is, a time difference in a waveform (for example, a pulse waveform) between the light emission signal and the light receiving signal, and determining the distance between the optical distance sensor and the object of distance measurement based on the phase difference.

### SUMMARY OF THE INVENTION

Incidentally, it is considered that in a motion capture device including the aforementioned depth sensor, for example, the motion of a person's finger and the like may be detected, and image display and the like may be performed according to the motion.

In conventional devices, a detection device that detects a person's motion and the like requires a white screen and the like. Accordingly, it is difficult for the device to detect a person's motion such as the motion of a person's hand on a transparent table, glass, and the like while utilizing the background.

The present invention aims to solve the problem of the conventional techniques, and an object thereof is to provide an optical device used for motion capture and the like that detects the motion of a person's hand and the like while observing the background, and a laminated film that is suitably used in the optical device.

The present invention has achieved the object by the following constitution.
[1] An optical device including a light source radiating infrared, an infrared sensor detecting infrared, and a reflection member selectively reflecting infrared, in which the infrared radiated from the light source is reflected from the reflection member, the infrared reflected from the reflection member is detected by the infrared sensor, and the reflection member is obtained by fixing cholesteric liquid crystalline phases and has a plurality of regions in which helical axes of the cholesteric liquid crystalline phases incline in different directions.
[2] The optical device described in [1], in which the reflection member has at least one of a dot array or a cholesteric liquid crystal layer, the dot array is obtained by two-dimensionally arranging dots formed by fixing the cholesteric liquid crystalline phases, the cholesteric liquid crystal layer is a layer obtained by fixing the cholesteric liquid crystalline phases, and in a cross-sectional view of the cholesteric liquid crystal layer observed with a scanning electron microscope, bright portions and dark portions resulting from the cholesteric liquid crystalline phases have a lenticular structure.
[3] The optical device described in [2] including the dot array and the cholesteric liquid crystal layer.
[4] The optical device described in [2] or [3], in which the reflection member has the cholesteric liquid crystal layer, and an average inter-peak distance in the lenticular structure of the bright portions and the dark portions resulting from the cholesteric liquid crystalline phases of the cholesteric liquid crystal layer is 1 to 50 μm.
[5] The optical device described in any one of [1] to [4], in which a haze of the reflection member is equal to or lower than 10%.
[6] A laminated film including a dot array and a cholesteric liquid crystal layer, in which the dot array is obtained by two-dimensionally arranging dots obtained by fixing cholesteric liquid crystalline phases, the cholesteric liquid crystal layer is a layer obtained by fixing cholesteric liquid crystalline phases, and in a cross-sectional view of the cholesteric liquid crystal layer observed with a scanning electron microscope, bright portions and dark portions resulting from the cholesteric liquid crystalline phases have a lenticular structure.

According to the present invention, an optical device used for motion capture and the like that detects a person's motion and the like can detect a person's hand and the like while observing background.

### BRIEF DESCRIPTION OF THE DRAWINGS

FIG. 1 is a view conceptually showing an example of an optical device according to an embodiment of the present invention.

FIG. 2 is a view conceptually showing an example of a reflection member of the optical device shown in FIG. 1.

FIG. 3 is a conceptual view for illustrating the action of the reflection member shown in FIG. 2.

FIG. 4 is a conceptual view for illustrating the action of the reflection member shown in FIG. 2.

FIG. 5 is a conceptual view which is for illustrating the action of the reflection member shown in FIG. 2 and shows a conventional constitution.

FIG. 6 is a conceptual view for illustrating the action of the reflection member shown in FIG. 2.

FIG. 7 is a conceptual view for illustrating the constitution of the reflection member shown in FIG. 2.

FIG. 8 is a conceptual view for illustrating the action of the optical device according to the embodiment of the present invention.

FIG. 9 is a conceptual view for illustrating the action of the optical device according to the embodiment of the present invention.

FIG. 10 is a view conceptually showing another example of the reflection member of the optical device according to the embodiment of the present invention.

FIG. 11 is a view conceptually showing still another example of the reflection member of the optical device according to the embodiment of the present invention.

FIG. 12 is a view conceptually showing yet another example of the reflection member of the optical device according to the embodiment of the present invention.

FIG. 13 is a conceptual view for illustrating a reflection member of an example.

### DESCRIPTION OF THE PREFERRED EMBODIMENTS

Hereinafter, an optical device and a laminated film according to an embodiment of the present invention will be specifically described based on suitable examples shown in the attached drawings.

In the present specification, a range of numerical values described using “to” means a range including the numerical values listed before and after “to” as a lower limit and an upper limit.

In the present specification, unless otherwise specified, for example, an angle such as “45°”, “parallel”, “perpendicular”, or “orthogonal” means that a difference between the angle and an accurate angle is within a range less than 5°. The difference between the aforementioned angle and an accurate angle is preferably less than 4°, and more preferably less than 3°.

In the present specification, “(meth)acrylate” is used as a term meaning “either or both of acrylate and methacrylate”.

In the present specification, “the same” includes a margin of error that is generally accepted in the technical field. Furthermore, in the present specification, “total”, “all”, “entirety”, and the like mean not only “100%”, but also “equal to or greater than 99%, equal to or greater than 95%, or equal to or greater than 90%” including a margin of error that is generally accepted in the technical field.

In the present specification, visible light refers to light of a wavelength visible to the human eye among electromagnetic waves, which is light in a wavelength range of 380 to 780 nm. Invisible light refers to light in a wavelength range shorter than 380 nm or light in a wavelength range longer than 780 nm.

Furthermore, although there is no particular limitation, among invisible lights, light of a wavelength range longer than 780 nm and equal to or shorter than 2,000 nm is called infrared.

In the present specification, retroreflection means the phenomenon of incidence rays being reflected in the incidence direction.

In the present specification, “haze” means a value measured using a haze meter NDH-2000 manufactured by NIPPON DENSHOKU INDUSTRIES Co., LTD.

Theoretically, haze means a value expressed by the following equation.

(Scatter transmittance of natural light at 380 to 780 nm)/(scatter transmittance of natural light at 380 to 780 nm+regular transmittance of natural light)×100%

The scatter transmittance is a value that can be calculated by subtracting a regular transmittance from an omni-directional transmittance obtained using a spectrophotometer and an integrating sphere unit. The regular transmittance is a transmittance at 0° based on values measured using the integrating sphere unit. That is, the lower the haze, the larger the amount of regularly transmitted light in the total amount of transmitted light.

In the present specification, provided that the minimum transmittance of an object (member) as a target is Tmin [%], a central wavelength of selective reflection refers to the average of two wavelengths representing half transmittance T½ [%] expressed by the following equation.

Equation for determining half transmittance: T½=100−(100−Tmin)÷2

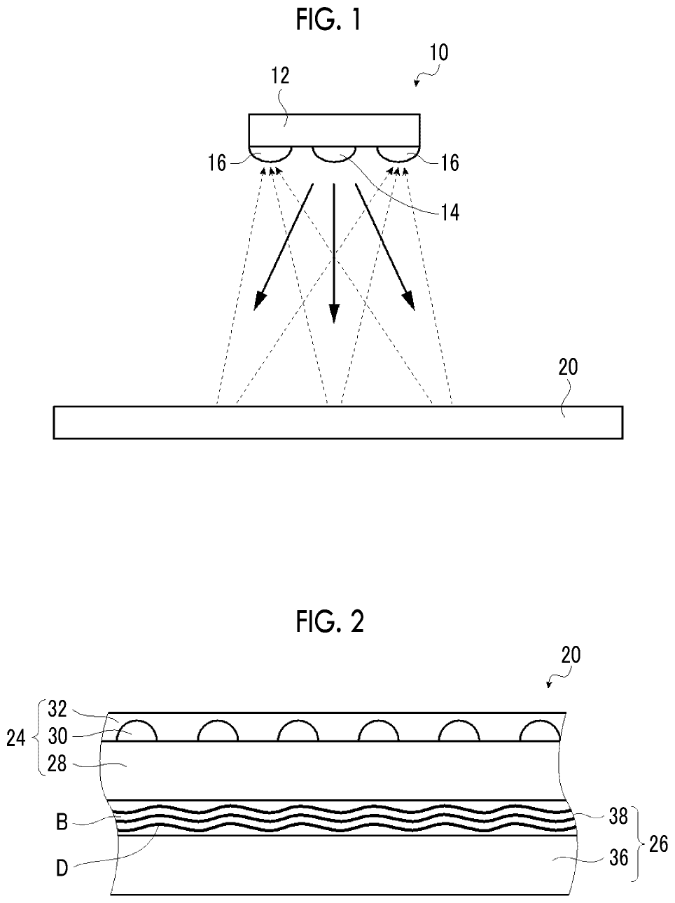

FIG. 1 conceptually shows an example of an optical device according to an embodiment of the present invention.

An optical device 10 shown in FIG. 1 has a light source 14 mounted on a base 12, infrared cameras 16, and a reflection member 20. In the optical device 10 illustrated in the drawing, for example, a laminated film according to an embodiment of the present invention is used as the reflection member 20.

In the optical device 10, the base 12 is a known optical surface plate holding the light source 14 and the infrared cameras 16.

The light source 14 is a known infrared light source used in a motion capture device such as an infrared light emitting diode (LED), an infrared laser, and the like.

The infrared cameras 16 are known infrared cameras (two-dimensional infrared sensors) used in a motion capture device such as a charge-coupled device (CCD) camera detecting infrared, a complementary metal-oxide-semiconductor (CMOS) camera, and the like so as to detect infrared.

The reflection member 20 is a sheet-like (plate-like) infrared reflection member that selectively reflects infrared by dots obtained by fixing cholesteric liquid crystalline phases and a layer obtained by fixing cholesteric liquid crystalline phases.

In the optical device 10, the infrared radiated from the light source 14 is reflected from an object, such as a person's hand positioned between the light source 14 and the reflection member 20, and the reflection member 20.

The infrared reflected from the object such as a person's hand and the reflection member 20 is incident on the infrared cameras 16 and measured.

The infrared detected by the infrared cameras 16 is output to an image analysis device for example. Based on the image captured by the infrared cameras 16, the image analysis device recognizes the shape of the object positioned between the light source 14 and the reflection member 20. Furthermore, based on the parallax obtained by two infrared cameras and the infrared reflection intensity, the image analysis device recognizes the distance between the base 12 and the object. The distance between the base 12 and the object is in other words a position from the base 12 in a depth direction.

Accordingly, in a case where the optical device 10 is used, by detecting the shape of an object such as a person's hand positioned between the base 12 and the reflection member 20 and detecting the position of the object in the depth direction, it is possible to detect the motion of the object. In the direction along which the light source 14 (base 12) and the reflection member 20 are spaced apart in the optical device 10, a direction to the reflection member 20 from the light source 14 is the depth direction. For example, the depth direction means a distance between the light source 14 and an object.

In the optical device 10, in order to accurately detect an object positioned between the base 12 and the reflection member 20, the reflection member 20 reflecting infrared as light to be detected needs to have retroreflection properties and appropriate diffuse reflection properties.

The reflection member 20 of the optical device 10 according to the embodiment of the present invention is obtained by fixing cholesteric liquid crystalline phases and has a plurality of regions in which helical axes of the cholesteric liquid crystalline phases incline in different directions. In this way, the reflection member 20 has both the retroreflection properties and appropriate diffuse reflection properties.

The reflection member 20 illustrated in the drawing has a dot array constituted with two-dimensionally arranged dots obtained by fixing cholesteric liquid crystalline phases and a cholesteric liquid crystal layer which is a layer obtained by fixing predetermined cholesteric liquid crystalline phases. In this way, the reflection member 20 has a plurality of regions in which the helical axes of the cholesteric liquid crystalline phases incline in different directions.

In a cross-sectional view of the cholesteric liquid crystal layer observed with a scanning electron microscope, bright portions and dark portions resulting from the cholesteric liquid crystalline phases have a lenticular structure. Hereinafter, in the present specification, “bright portions and dark portions resulting from the cholesteric liquid crystalline phases have a lenticular structure” means that the bright portions and the dark portions described above are observed in a cross-sectional view of the cholesteric liquid crystal layer observed with a scanning electron microscope.

FIG. 2 conceptually shows an example of the reflection member 20.

The reflection member 20 illustrated in the drawing is constituted, for example, with a dot film 24 and a liquid crystal layer film 26 that are laminated. That is, the reflection member 20 used in the optical device 10 illustrated in the drawing is the laminated film according to the embodiment of the present invention as described above.

The reflection member in the optical device according to the embodiment of the present invention is not limited to the reflection member 20 illustrated in the drawing that has both the dot film 24 and liquid crystal layer film 26. That is, in the optical device according to the embodiment of the present invention, the reflection member may be constituted only with the dot film 24 or the liquid crystal layer film 26.

The dot film 24 and the liquid crystal layer film 26 are bonded to each other by a bonding layer provided between these films although the bonding layer is not shown in the drawing. The bonding layer may be a layer formed of an adhesive, a layer formed of a pressure sensitive adhesive, or a layer formed of a material having the characteristics of both the adhesive and pressure sensitive adhesive. Accordingly, as the bonding layer, known materials may be used which are used for bonding sheet-like substances in an optical device and the like, such as an optical clear adhesive (OCA), an optical transparent double-sided tape, and an ultraviolet curable type resin.

The dot film 24 is a film-like substance obtained by two-dimensionally arranging dots 30 obtained by fixing cholesteric liquid crystalline phases, and has a support 28, dots 30, and an overcoat layer 32.

The liquid crystal layer film 26 has a support 36 and a cholesteric liquid crystal layer 38 obtained by fixing cholesteric liquid crystalline phases. As being conceptually shown in FIG. 2, in the cholesteric liquid crystal layer 38, bright portions B and dark portions D resulting from the cholesteric liquid crystalline phases have a lenticular structure.

[Dot Film]

The dot film 24 has a support 28, the dots 30 two-dimensionally arranged and fixed on one surface of the support 28, and the overcoat layer 32 which allows the dots 30 to be embedded therein and is laminated on the support 28. As described above, the dots 30 are obtained by fixing cholesteric liquid crystalline phases.

<Support>

The support 28 of the dot film 24 supports the dots 30 obtained by fixing cholesteric liquid crystalline phases which will be described later.

It is preferable that the support 28 has a low reflectivity for light having the wavelength of light (infrared) reflected from the dots 30. Furthermore, it is preferable that the support 28 does not contain a material reflecting light having the wavelength of light reflected from the dots 30.

It is preferable that the support 28 is transparent in the visible range. Furthermore, although the support 28 may be colored, it is preferable that the support 28 is not colored or slightly colored.

In the present specification, in a case where a substance is “transparent”, specifically, a non-polarization transmittance (total light transmittance) of the substance at a wavelength of 380 to 780 nm may be equal to or higher than 50%, preferably equal to or higher than 70%, and more preferably equal to or higher than 85%. The transmittance may be measured using, for example, a haze meter NDH-2000 manufactured by NIPPON DENSHOKU INDUSTRIES Co., LTD.

The haze of the support 28 is preferably equal to or lower than 30%, more preferably 0.1% to 25%, and even more preferably 0.1% to 10%.

The thickness of the support 28 is not particularly limited, but is preferably 5 to 1,000 μm, more preferably 10 to 250 μm, and even more preferably 15 to 150 μm.

It is preferable that support 28 has low Re(λ) and low Rth(λ).

Specifically, Re(550) of the support 28 is preferably 0 to 20 nm, and more preferably 0 to 10 nm. Furthermore, Rth(550) of the support 28 is preferably 0 to 50 nm, and more preferably 0 to 40 nm.

The support 28 may be constituted with a single layer or multiple layers. In a case where the support 28 is constituted with a single layer, examples thereof include supports formed of glass, triacetyl cellulose (TAC), polyethylene terephthalate (PET), polycarbonate, polyvinyl chloride, acryl, polyolefin, and the like. In a case where the support 28 is constituted with multiple layers, examples thereof include a support, which includes any of the aforementioned single-layered supports as a substrate and other layers provided on surfaces of the substrate, and the like.

An undercoat layer may be provided on a surface of the support 28, that is, between the support 28 and dots 30 which will be described later. The undercoat layer is preferably a resin layer, and more preferably a transparent resin layer. Examples of the undercoat layer include a layer for controlling the shape of the dots 30 at the time of forming the dots 30, a layer for improving adhesion characteristics between the support 28 and the dots 30, an alignment film for controlling the alignment of molecules of a polymerizable liquid crystal compound at the time of forming the dots 30, and the like.

It is preferable that the undercoat layer has a low transmittance for light having a wavelength of light reflected from the dots 30, and does not contain a material reflecting light having a wavelength of light reflected from the dots 30. Furthermore, it is preferable that the undercoat layer is transparent. It is also preferable that the undercoat layer is a resin-containing layer obtained by curing a composition containing a polymerizable compound that is directly applied to a surface of the support. Examples of the polymerizable compound include non-liquid crystal compounds such as a (meth)acrylate monomer and a urethane monomer.

The thickness of the undercoat layer is not particularly limited, but is preferably 0.01 to 50 μm, and more preferably 0.05 to 20 μm.

<Dots>

As described above, the dots 30 are dots obtained by fixing cholesteric liquid crystalline phases.

In the present invention, the dots 30 are dots which selectively reflect right-circularly polarized or left-circularly polarized infrared and transmit other lights. That is, dots 30 are dots obtained by fixing cholesteric liquid crystalline phases having a central wavelength of selective reflection in the infrared range.

As it is known, a cholesteric liquid crystalline phase reflects any of right circular polarization and left circular polarization. The dots 30 may reflect right circular polarization or left circular polarization. In the dot film 24, both the dot 30 reflecting right circular polarization and dot 30 reflecting left circular polarization may be present.

All the dots 30 are dots obtained by fixing cholesteric liquid crystalline phases. That is, the dots 30 are dots formed of a liquid crystal material having a cholesteric structure.

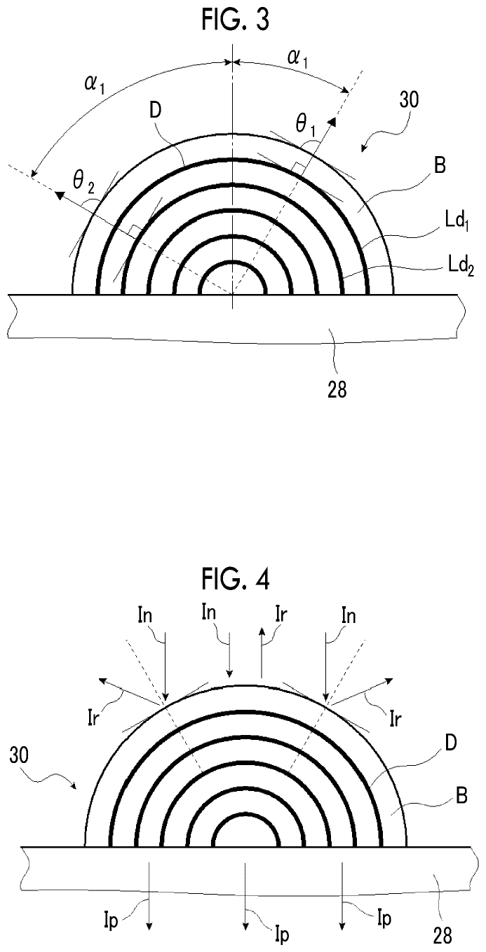

It is preferable that in a cross section of each of the dots 30 observed with a scanning electron microscope (SEM), the cholesteric liquid crystalline phases forming the dot 30 have bright portions B and dark portions D that form a streak pattern and includes a moiety whose height continuously increases up to the maximum height toward the center of the dot 30 from the edge of the dot 30. Furthermore, in this moiety, an angle formed between the normal line of a line, which is formed by the first dark portion from the surface of the dot 30 on the side opposite to the support 28, and the surface of the dot 30 is preferably within a range of 70° to 90° (see FIG. 3). This point will be specifically described later.

The helical axis of each of the cholesteric liquid crystalline phases is perpendicular to the streak pattern formed by the bright portions B and the dark portions D. As will be specifically described later, in each of the dots 30, the helical axis of each of the cholesteric liquid crystalline phases inclines at a predetermined angle away from the normal direction of the support 28 at a plurality of positions. That is, each of the dots 30 has a plurality of regions in which the helical axes of the cholesteric liquid crystalline phases incline in different directions.

In the dot film 24, the dots 30 may be arranged regularly or irregularly as long as the dots 30 are two-dimensionally arranged.

Furthermore, the density of the dots 30 arranged in the dot film 24 may be uniform over the entire film, or the dot film 24 may have regions in which the arranged dots 30 have different densities.

The density of the dots 30 arranged in the dot film 24 is not particularly limited, and may be appropriately set according to diffusivity (viewing angle), transparency, and the like required to the reflection member.

From the viewpoint of obtaining high transparency and from the viewpoint of appropriate density which makes it possible to manufacture the dot film 24 without a defect such as aggregation or deletion of the dots 30 at the time of manufacturing, in a case where the dots 30 are seen in the normal direction of the main surface of the support 28, an area ratio of the dots 30 to the support 28 is preferably 1% to 90.6%, more preferably 2% to 50%, and even more preferably 4% to 30%. The main surface is the largest surface of a sheet-like substance (plate-like substance).

For determining the area ratio of the dots 30, in an image obtained using a microscope such as a laser microscope, SEM, or a transmission electron microscope (TEM), an area ratio in a region having an area of 1 mm² may be measured, and the average of, for example, 5 regions described above may be adopted as the area ratio of the dots 30.

In view of obtaining high transparency, a pitch of adjacent dots 30 is preferably 20 to 500 μm, more preferably 20 to 300 μm, and even more preferably 20 to 150 μm. The pitch of the dots 30 is a center-to-center distance between the dots 30.

In the dot film, all the dots 30 may have the same diameter and/or the same shape, or some of the dots 30 may have different diameters and/or different shapes. It is preferable that all the dots 30 have the same diameter and/or the same shape. For example, it is preferable that the dots 30 are formed under the same condition such that the dots have the same diameter and the same shape.

In the present specification, in a case where the dots 30 are described, the description is applicable to all the dots 30 constituting the reflection member 20. However, in the present invention, it is acceptable that the described dots 30 include dots that do not fit the description due to errors and the like accepted in the technical field of the related art.

It is preferable that the dots 30 look circular in a case where the dots are seen in the normal direction of the main surface of the support 28. For example, the dots 30 preferably have a semispherical shape (approximately semispherical shape), a spherical segment shape (approximately spherical segment shape), a truncated sphere shape, a conical shape, a truncated cone shape, and the like. Hereinafter, the normal direction of the main surface of the support 28 will be described as “normal direction of the support” as well.

The dots 30 do not need to be perfectly circular and may be approximately circular. The center of each of the dots 30 means the center or the centroid of the circle. The dots 30 may be circular on average, and some of the dots 30 may have a shape that does not correspond to a circle.

In a case where the dots 30 are seen in the normal direction of the support, the average diameter of the dots 30 is preferably 10 to 200 μm, and more preferably 20 to 120 μm.

The diameter of each of the dots 30 can be obtained by measuring the length of a straight line, which starts from one edge of the dot 30, passes through the center of the dot 30, and reaches the other edge, in an image obtained using a microscope such as a laser microscope, SEM, or TEM. The edge of the dot 30 is the border or the boundary portion of the dot 30. The number of dots 30 and the distance between dots 30 can also be checked in an image obtained using a microscope such as a laser microscope, SEM, or TEM.

In a case where the shape of the dot 30 seen in the normal direction of the support is not circular, the diameter (equivalent circular diameter) of a circle having a circular area equivalent to a projected area of the dot 30 is adopted as the diameter of the dot 30.

For determining the average diameter of the dots 30, the diameters of 10 dots 30 that are randomly selected are measured by the method described above, and an arithmetic mean thereof is calculated.

The height of each of the dots 30 can be checked by focal position scanning by a laser microscope or checked from a cross-sectional view of the dots obtained using a microscope such as SEM or TEM.

The average maximum height of the dots 30 is preferably 1 to 40 μm, more preferably 3 to 30 μm, and even more preferably 5 to 20 μm.

<<Optical Properties of Dots>>

The dots 30 selectively reflect infrared.

The wavelength of light that is selectively reflected from the dots 30 (cholesteric liquid crystal layer 38 which will be described later) can be controlled (selected) by the helical pitch of the cholesteric liquid crystalline phases forming the dots 30.

Furthermore, the directions of the helical axes of the cholesteric liquid crystalline phases forming the dots 30 in the dot film 24 are controlled as will be described later. Accordingly, the light incident on the dots 30 undergoes not only regular reflection but also reflection in various directions. By two-dimensionally arranging the dots 30, the dot film 24 obtains retroreflection properties and appropriate diffuse reflection properties.

Although the dots 30 may be colored, it is preferable that the dots 30 may not be colored or slightly colored. In a case where the dots 30 are not colored or slightly colored, the transparency of the reflection member 20 can be improved. The reflection member 20 is a laminated film according to an embodiment of the present invention.

<<Cholesteric Liquid Crystalline Phase>>

The cholesteric liquid crystalline phase is known to exhibit selective reflectivity at a specific wavelength. A central wavelength λ of selective reflection depends on a pitch P (=helical period) of the helical structure in the cholesteric liquid crystalline phase and have a relationship of λ=n×P with an average refractive index n of the cholesteric liquid crystalline phase. Therefore, in a case where the pitch of the helical structure is controlled, the central wavelength of selective reflection can be controlled. Accordingly, in the present invention, the helical pitch of each of the cholesteric liquid crystalline phases forming the dots 30 (cholesteric liquid crystal layer 38) is controlled such that infrared is reflected.

The pitch of each of the cholesteric liquid crystalline phases depends on the type of a chiral agent used together with a polymerizable liquid crystal compound at the time of forming the dots or the concentration of the chiral agent added. Accordingly, by controlling the type and the concentration of the chiral agent, a desired pitch can be obtained.

The control of pitch is specifically described in a research report No. 50 (2005), p. 60-63 of FUJIFILM Corporation. For measuring the sense or pitch of a helix, it is possible to use the methods described in “Introduction to Experiment of Liquid Crystal Chemistry” (edited by The Japanese Liquid Crystal Society, Sigma Publication Ltd, 2007, p. 46) and “Handbook of Liquid Crystal” (Editorial Committee of Handbook of Liquid Crystal, MARUZEN Co., Ltd. p. 196).

In the cross section of a dot 30 observed with SEM, the cholesteric liquid crystalline phase has a streak pattern of bright portions and dark portions (see FIG. 3). Among the repeating bright portions and the dark portions, two bright portions and two dark portions correspond to one helical pitch (one helical turn). Therefore, the pitch can be measured from a cross-sectional view obtained using SEM. In each of the dots 30, a normal line of each line in the streak pattern is the direction of the helical axis of each of the cholesteric liquid crystalline phases.

The cholesteric liquid crystalline phase reflects circular polarization. That is, in the reflection member 20, the dots 30 in the dot film 24 reflect circular polarization. Whether the cholesteric liquid crystalline phase reflects right circular polarization or left circular polarization depends on the twisted direction of the helix. In a case where the helix of the cholesteric liquid crystalline phase is a right-handed twist, the cholesteric liquid crystalline phase selectively reflects right circular polarization. In a case where the helix of the cholesteric liquid crystalline phase is a left-handed twist, the cholesteric liquid crystalline phase selectively reflects left circular polarization.

The sense of the helix of each of the cholesteric liquid crystalline phases can be controlled by the type of a liquid crystal compound forming the dots 30 (cholesteric liquid crystal layer 38) or the type of a chiral agent added.

A half-width Δλ (nm) of a selective reflection band (circular polarization reflection band) in which selective reflection occurs depends on Δn of the cholesteric liquid crystalline phase and the pitch P of the helix, and satisfies a relationship of Δλ=Δn×P. Therefore, by adjusting Δn, the width of the selective reflection band can be controlled. Δn can be controlled by the type of the liquid crystal compound forming the dots 30 (cholesteric liquid crystal layer 38), a mixing ratio thereof, and the temperature at the time of fixing the alignment. The half-width of the selective reflection band is controlled according to the use of the reflection member 20. For example, the half-width may be 50 to 500 nm, and preferably 100 to 300 nm.

In a cross section of each of the dots 30 obtained by fixing the cholesteric liquid crystalline phases, the bright portions B and the dark portions D form a streak pattern. In a case where each of the dots 30 obtained by fixing the cholesteric liquid crystalline phases is checked in a cross-sectional view observed with SEM, it is preferable that an angle formed between a normal line of a line, which is formed by the first dark portion D from the surface of the dot 30 on the side opposite to the support 28, and the surface of the dot 30 on the side opposite to the support 28 is preferably within a range of 70° to 90°.

Hereinafter, “surface of the dot 30 on the side opposite to the support 28” will be simply described as “surface of the dot 30” as well.

FIG. 3 is a view schematically showing a cross section of a dot 30. In FIG. 3, the lines formed by the dark portions D are shown as thick lines. As shown in FIG. 3, an angle θ₁ formed between a normal line (broken line) of a line Ld₁ formed by the first dark portion D and the surface (tangent thereof) of the dot 30 is preferably 70° to 90°.

Provided that positions on the surface of the dot 30 are represented by an angle α₁ relative to a line (dashed line) which passes through the center of the dot 30 and is perpendicular to the surface of the support 28, an angle formed between the normal line of the line Ld₁, which is formed by the first dark portion D from the surface of the dot 30, and the surface of the dot 30 is preferably within a range of 70° to 90° at a position where the angle α₁ is 30° and a position where the angle α₁ is 60°, and more preferably within a range of 70° to 90° at all the positions on the surface of the dot 30.

That is, it is preferable that each of the dots 30 is not a dot in which the angle described above is satisfied in a portion of the surface of the dot 30, for example, a dot in which the angle described above is intermittently satisfied in a portion of the surface of the dot 30, but a dot in which the angle described above is continuously satisfied. In a case where the surface of the dot 30 is a curve in the cross-sectional view, the angle formed between the normal line of the line formed by the dark portion D and the surface of the dot means an angle formed between the tangent of the surface of the dot 30 and the normal line. The aforementioned angle is described as an acute angle and means an angle within a range of 70° to 110° in a case where the angle formed between the normal line and the surface of the dot 30 is described as an angle of 0° to 180°.

In the cross-sectional view of each of the dots 30, an angle θ₂ formed between a line Ld₂, which is formed by the second dark portion D from the surface of the dot 30, and the surface of the dot 30 is preferably within a range of 70° to 90°. It is more preferable that an angle formed between normal lines of all the lines, which are formed by the third and fourth dark portions D from the surface of the dot 30, and the surface of the dot 30 is within a range of 70° to 90°. It is even more preferable that an angle formed between the normal line of all the lines, which are formed by the fifth to twelfth dark portions or the following dark portions from the surface of the dot 30, and the surface of the dot 30 is within a range of 70° to 90°.

The angle formed between the normal line of the line formed by the dark portion D and the surface of the dot 30 is more preferably 80° to 90°, and even more preferably 85° to 90°.

In the cross-sectional view of each of the dots 30 obtained using SEM, the helical axis of the cholesteric liquid crystalline phase is found to form an angle within a range of 70° to 90° together with the surface (tangent of the surface) of the dot 30 on the surface of the dot 30.

Due to this structure, the light, which is incident on the dot 30 in a direction inclining away from the normal direction of the support 28, can be caused to incident on the surface of the dot 30 at an angle such that the light is nearly parallel to the direction of the helical axis of the cholesteric liquid crystalline phase. Therefore, the light incident on the dot 30 can be reflected in various directions.

The dots 30 cause the incidence ray to undergo regular reflection based on the helical axes of the cholesteric liquid crystalline phases. Accordingly, as being conceptually shown in FIG. 4, an incidence ray In incident in the normal direction of the support 28 is reflected as a reflected ray Ir that is reflected from around the center of the dot 30 in a direction parallel to the normal direction of the support. In contrast, at a position deviating from the center of the dot 30, the reflected ray Ir is reflected in a direction different from the normal direction of the support 28. The position deviating from the center of the dot 30 is in other words a position at which the helical axis of the cholesteric liquid crystalline phase inclines away from the normal direction of the support 28. Therefore, the dot 30 can reflect the light incident on the dot 30 in various directions. As a result, the dot film 24 can obtain retroreflection properties and appropriate diffuse reflection properties. Furthermore, the light Ip transmitted through the dot 30 is transmitted in the same direction as the incidence ray In. Consequently, it is possible to reduce haze by inhibiting the scattering of the transmitted light and to improve transparency.

It is preferable that the dot 30 can reflect the light incident in the normal direction of the support 28 in all directions. Particularly, in the dot 30, it is preferable that an angle (half intensity angle) at which the front luminance (peak luminance) halves can be equal to or greater than 35° such that the dot 30 has high reflectivity.

It is preferable that the helical axis of each of the cholesteric liquid crystalline phases forms an angle within a range of 70° to 90° together with the surface of the dot 30, such that the angle formed between the normal direction of the line formed by the first dark portion D from the surface and the normal direction of the support 28 continuously decreases as the height described above continuously increases.

The aforementioned cross-sectional view is a cross-sectional view captured in any direction including a moiety whose height continuously increases up to the maximum height toward the center from the edge of the dot. Typically, the cross-sectional view may be a cross-sectional view captured along any plane perpendicular to the support including the center of the dot.

<<Method for Forming Dots>>

The dots 30 can be obtained by fixing cholesteric liquid crystalline phases in the form of dots.

The structure obtained by fixing the cholesteric liquid crystalline phases may retain the alignment of molecules of a liquid crystal compound forming the cholesteric liquid crystalline phases. Typically, the structure may be established by aligning molecules of a polymerizable liquid crystal compound in the form of cholesteric liquid crystalline phases, polymerizing and curing the compound by means of ultraviolet irradiation, heating, and the like so as to form a layer without fluidity, and applying an external field or external force thereto so as to change the state of the layer without changing the alignment form.

The structure obtained by fixing the cholesteric liquid crystalline phases just needs to retain the optical properties of the cholesteric liquid crystalline phases, and the liquid crystal compound does not need to exhibit liquid crystallinity. For example, the polymerizable liquid crystal compound may lose liquid crystallinity by turning into a high-molecular-weight compound through a curing reaction.

One of the examples of materials used for forming the dots 30 obtained by fixing the cholesteric liquid crystalline phases includes a liquid crystal composition containing a liquid crystal compound (coating solution for forming dots). The liquid crystal compound is preferably a polymerizable liquid crystal compound.

It is preferable that the liquid crystal composition containing a liquid crystal compound used for forming the dots 30 further contains a surfactant. In addition, the liquid crystal composition used for forming the dots 30 may further contain a chiral agent and a polymerization initiator.

—Polymerizable Liquid Crystal Compound—

The polymerizable liquid crystal compound may be a rod-like liquid crystal compound or a disk-like liquid crystal compound. As the polymerizable liquid crystal compound, a rod-like liquid crystal compound is preferable.

Examples of the rod-like polymerizable liquid crystal compound forming the cholesteric liquid crystalline phases include rod-like nematic liquid crystal compounds. As the rod-like nematic liquid crystal compounds, azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyldioxanes, tolanes, and alkenylcyclohexyl benzonitriles are preferably used. Not only low-molecular-weight liquid crystal compounds, but also high-molecular-weight liquid crystal compounds can be used.

The polymerizable liquid crystal compound can be obtained by introducing a polymerizable group into a liquid crystal compound. Examples of the polymerizable group include an unsaturated polymerizable group, an epoxy group, and an aziridinyl group. Among these, an unsaturated polymerizable group is preferable, and an ethylenically unsaturated polymerizable group is more preferable. The polymerizable group can be introduced into a molecule of a liquid crystal compound by various methods. The number of polymerizable groups contained in the polymerizable liquid crystal compound is preferably 1 to 6, and more preferably 1 to 3. Examples of the polymerizable liquid crystal compound include the compounds described in Makromol. Chem., vol. 190, p. 2255 (1989), Advanced Materials, vol. 5, p. 107 (1993), U.S. Pat. Nos. 4,683,327A, 5,622,648A, 5,770,107A, WO95/022586A, WO95/024455A, WO97/000600A, WO98/023580A, WO98/052905A, JP1989-272551A (JP-H01-272551A), JP1994-016616A (JP-H06-016616A), JP1995-110469A (JP-H07-110469A), JP1999-080081A (JP-H11-080081A), JP2001-328973A, and the like. Two or more kinds of polymerizable liquid crystal compounds may be used in combination. In a case where two or more kinds of polymerizable liquid crystal compounds are used in combination, the alignment temperature can be reduced.

The amount of the polymerizable liquid crystal compound added to the liquid crystal composition is, with respect to the mass of solid contents (mass excluding solvents) of the liquid crystal composition, preferably 75% to 99.9% by mass, more preferably 80% to 99% by mass, and particularly preferably 85% to 90% by mass.

—Surfactant—

In a case where a surfactant is added to the liquid crystal composition used for forming the dots 30, molecules of the polymerizable liquid crystal compound are horizontally aligned on the side of air interface at the time of forming the dots 30, and accordingly, the helical axis is controlled as described above in the obtained dots 30 are obtained.

Generally, in order to form dots, it is necessary to prevent a decrease in surface tension so as to retain the shape of liquid droplets at the time of printing. Therefore, it is amazing that the dots 30 can be formed even though a surfactant is added and that the dots 30 exhibiting high retroreflection properties in multiple directions can be obtained. In a case where a surfactant is used, it is possible to form the dots 30 in which the surface of each of the dots 30 and the support 28 form an angle equal to or greater than 40° at the edge of the dot 30. That is, in a case where a surfactant is added at the time of forming the dots 30, the contact angle between the dot 30 and the support 28 can be within a range of angle that satisfies both the high diffusivity and high transparency.

As a surfactant, a compound is preferable which can function as an alignment control agent making a contribution to the stable and rapid formation of cholesteric liquid crystalline phases in a planar alignment. Examples of the surfactant include a silicone-based surfactant and a fluorine-based surfactant. Among these, a fluorine-based surfactant is preferable.

Specifically, examples of the surfactant include the compounds exemplified in paragraphs “0082” to “0090” in JP2014-119605A, the compounds exemplified in paragraphs “0031” to “0034” in JP2012-203237A, the compounds exemplified in paragraphs “0092” and “0093” in JP2005-099248A, the compound exemplified in paragraphs “0076” to “0078” and paragraphs “0082” to “0085” in JP2002-129162A, the fluorine (meth)acrylate-based polymers described in paragraphs “0018” to “0043” in JP2007-272185A, and the like.

One kind of surfactant may be used singly, or two or more kinds of surfactants may be used in combination.

As the fluorine-based surfactant, the compounds described in paragraphs “0082” to “0090” in JP2014-119605A are preferable.

The amount of the surfactant added to the liquid crystal composition with respect to the total mass of the polymerizable liquid crystal compound is preferably 0.01% to 10% by mass, more preferably 0.01% to 5% by mass, and even more preferably 0.02% to 1% by mass.

—Chiral Agent (Optically Active Compound)—

The chiral agent has a function of inducing the helical structure of the cholesteric liquid crystalline phases. Because the twisted direction or the helical pitch of the induced helix varies with the compound, the chiral agent may be selected according to the purpose.

The chiral agent is not particularly limited, and it is possible to use known compounds (for example, those described in Chapter 3, 4-3. <Chiral agents for twisted nematic (TN) and super twisted nematic (STN)>in Handbook of Liquid Crystal Device, edited by the 142^{nd} committee of Japan Society for The Promotion of Science, p. 199, 1989), isosorbide, and isomannide derivatives.

Generally, the chiral agent contains asymmetric carbon atoms. However, an axially asymmetric compound and a planarly asymmetric compound not containing asymmetric carbon atoms can also be used as the chiral agent. Examples of the axially asymmetric compound and the planarly asymmetric compound include binaphthyl, helicene, paracyclophane, and derivatives of these. The chiral agent may have a polymerizable group. In a case where both the chiral agent and liquid crystal compound have a polymerizable group, by a polymerization reaction between the polymerizable chiral agent and the polymerizable liquid crystal compound, it is possible to form a polymer having a repeating unit derived from the polymerizable liquid crystal compound and a repeating unit derived from the chiral agent. In this aspect, the polymerizable group contained in the polymerizable chiral agent is preferably the same type of polymerizable group as the polymerizable group contained in the polymerizable liquid crystal compound. Accordingly, the polymerizable group of the chiral agent is also preferably an unsaturated polymerizable group, an epoxy group, or an aziridinyl group, more preferably an unsaturated polymerizable group, and even more preferably an ethylenically unsaturated polymerizable group.

Furthermore, the chiral agent may be a liquid crystal compound.

It is preferable that the chiral agent has a photoisomerizing group because then a pattern of an intended reflection wavelength corresponding to an emission wavelength can be formed by irradiating the polymerizable liquid crystal composition with actinic rays or the like through a photomask after coating and alignment. As the photoisomerizing group, an isomerizing moiety of a compound exhibiting photochromic properties, an azo group, an azoxy group, and a cinnamoyl group are preferable. Specifically, it is possible to use the compounds described in JP2002-080478A, JP2002-080851A, JP2002-179668A, JP2002-179669A, JP2002-179670A, JP2002-179681A, JP2002-179682A, JP2002-338575A, JP2002-338668A, JP2003-313189A, JP2003-313292A, and the like.

The content of the chiral agent in the liquid crystal composition with respect to the amount of the polymerizable liquid crystal compound is preferably 0.01 to 200 mol %, and more preferably 1 to 30 mol %.

—Polymerization Initiator—

In a case where the liquid crystal composition contains a polymerizable compound, it is preferable that the liquid crystal composition contains a polymerization initiator. In an aspect in which a polymerization reaction is caused by ultraviolet irradiation, as the polymerization initiator, it is preferable to use a photopolymerization initiator that can initiate the polymerization reaction by ultraviolet irradiation. Examples of the photopolymerization initiator include an α-carbonyl compound (described in U.S. Pat. Nos. 2,367,661A and 2,367,670A), an acyloin ether (described in U.S. Pat. No. 2,448,828A), an α-hydrocarbon-substituted aromatic acyloin compound (described in U.S. Pat. No. 2,722,512A), a polynuclear quinone compound (described in U.S. Pat. Nos. 3,046,127A and 2,951,758A), a combination of triarylimidazole dimer and p-aminophenylketone (described in U.S. Pat. No. 3,549,367A), acrydine and phenazine compounds (described in JP1985-105667A (JP-S60-105667A) and U.S. Pat. No. 4,239,850A), an oxadiazole compound (described in U.S. Pat. No. 4,212,970A), and the like.

The content of the photopolymerization initiator in the liquid crystal composition with respect to the content of the polymerizable liquid crystal compound is preferably 0.1% to 20% by mass, and more preferably 0.5% to 12% by mass.

—Crosslinking Agent—

For the purpose of improving film hardness after curing and improving durability, the liquid crystal composition may optionally contain a crosslinking agent. As the crosslinking agent, those cured by ultraviolet, heat, moisture, or the like can be suitably used.

The crosslinking agent is not particularly limited and can be appropriately selected according to the purpose. Examples of the crosslinking agent include a polyfunctional acrylate compound such as trimethylolpropane tri(meth)acrylate and pentaerythritol tri(meth)acrylate; an epoxy compound such as glycidyl (meth)acrylate and ethylene glycol diglycidyl ether; an aziridine compound such as 2,2-bishydroxymethylbutanol-tris[3-(1-aziridinyl)propionate] and 4,4-bis(ethyleneiminocarbonylamino)diphenylmethane; an isocyanate compound such as hexamethylene diisocyanate and biuret-type isocyanate; a polyoxazoline compound having an oxazoline group on a side chain; an alkoxysilane compound such as vinyltrimethoxysilane and N-(2-aminoethyl)3-aminopropyl trimethoxysilane; and the like. Furthermore, depending on the reactivity of the crosslinking agent, a known catalyst can be used. In a case where the catalyst is used, it is possible to improve the productivity in addition to the film hardness and durability. One kind of crosslinking agent may be used singly, or two or more kinds of crosslinking agents may be used in combination.

The content of the crosslinking agent with respect to the mass of solid contents in the liquid crystal composition is preferably 3% by mass to 20% by mass, and more preferably 5% by mass to 15% by mass. In a case where the content of the crosslinking agent is within the above range, a crosslinking density improving effect can be obtained, and the stability of the cholesteric liquid crystalline phases can be further improved.

—Other Additives—

In a case where an ink jet method, which will be described later, is used for forming the dots 30, in order to obtain physical properties of ink that are generally required, the liquid crystal composition may contain a monofunctional polymerizable monomer. Examples of the monofunctional polymerizable monomer include 2-methoxyethyl acrylate, isobutyl acrylate, isooctyl acrylate, isodecyl acrylate, octyl/decyl acrylate, and the like.

Furthermore, if necessary, within a range that does not deteriorate the optical performance and the like, a polymerization inhibitor, an antioxidant, an ultraviolet absorber, a light stabilizer, a coloring material, metal oxide particles, and the like can be added to the liquid crystal composition.

At the time of forming the dots 30, it is preferable that the liquid crystal composition is used as a liquid.

The liquid crystal composition may contain a solvent. The solvent is not particularly limited, and can be appropriately selected according to the purpose. As the solvent, an organic solvent is preferably used.

The organic solvent is not particularly limited, and can be appropriately selected according to the purpose. Examples thereof include ketones such as methyl ethyl ketone and methyl isobutyl ketone, alkyl halides, amides, sulfoxides, heterocyclic compounds, hydrocarbons, esters, ethers, and the like. One kind of each of these solvents may be used singly, or two or more kinds of these solvents may be used in combination. Considering the environmental load, ketones are preferable among the above. The aforementioned component such as the monofunctional polymerizable monomer may function as a solvent.

At the time of forming the dots 30, the liquid crystal composition is applied in the form of dots onto the support 28, the molecules of the liquid crystal compound are then aligned in the state of cholesteric liquid crystalline phases, and then the liquid crystal compound is cured so as to form the dots 30.

At the time of forming the dots 30, it is preferable to apply the liquid crystal composition onto the support 28 by jetting. As a printing method, an ink jet method, a gravure printing method, a flexographic printing method, and the like can be used without particular limitation. Among these, an ink jet method is preferable. The pattern of the dots 30 can also be formed using known printing techniques.

The liquid crystal composition applied onto the support 28 is dried or heated if necessary and then cured, thereby forming the dots 30. The molecules of the polymerizable liquid crystal compound in the liquid crystal composition may be aligned in the form of cholesteric liquid crystalline phases by the step of drying and/or heating. In a case where the liquid crystal composition is heated, the heating temperature is preferably equal to or lower than 200° C., and more preferably equal to or lower than 130° C.

If necessary, the aligned molecules of the liquid crystal compound are further polymerized. The polymerization may be any of thermal polymerization and photopolymerization performed by light irradiation, but is preferably photopolymerization. It is preferable to use ultraviolet for the light irradiation. The irradiation energy is preferably 20 to 50 J/cm², and more preferably 100 to 1,500 mJ/cm². In order to accelerate the photopolymerization reaction, the light irradiation may be performed under heating conditions or in a nitrogen atmosphere. The wavelength of the ultraviolet for irradiation is preferably 250 to 430 nm. From the viewpoint of stability, it is preferable that the polymerization reaction rate is high. The polymerization reaction rate is preferably equal to or higher than 70%, and more preferably equal to or higher than 80%.

The polymerization reaction rate can be determined by measuring the consumption rate of polymerizable functional groups by using an infrared (IR) absorption spectrum.

<Overcoat Layer>

The dot film 24 has the overcoat layer 32 which allows the dots 30 to be embedded therein and is laminated on the support 28.

The overcoat layer 32 may be provided on a surface of the support 28 on which the dots 30 are formed. It is preferable that the overcoat layer 32 smoothens the surface of the dot film 24.

Although the overcoat layer 32 is not particularly limited, it is preferable that a difference in refractive index between the overcoat layer 32 and the dots 30 is small. The difference in refractive index is preferably equal to or smaller than 0.04. Because the refractive index of the dots 30 is about 1.6, the overcoat layer 32 is preferably a resin layer having a refractive index of about 1.4 to 1.8.

In a case where the overcoat layer 32 having a refractive index close to the refractive index of the dots 30 is used, an angle (polar angle) formed between the light incident on the dots 30 and the normal line can be reduced. For example, in a case where light is caused to incident on the reflection member 20 at a polar angle of 45° by using the overcoat layer 32 having a refractive index of 1.6, the polar angle at which the light is actually incident on the dots 30 can be set to be about 27°. Accordingly, in a case where the overcoat layer 32 is used, the polar angle of light retroreflected from the reflection member 20 can widens, and even though the angle formed between the surface of the dot 30 and the support 28 is small, high retroreflection properties are obtained in a wider range. Furthermore, the overcoat layer 32 may function as an antireflection layer or a hardcoat layer.

Examples of the overcoat layer 32 include a resin layer obtained by coating a surface of the support 28, on which the dots 30 are formed, with a composition containing a monomer and then curing the coating film, and the like.

The resin used in the overcoat layer 32 is not particularly limited, and may be selected in consideration of the adhesion between the support 28 and the dots 30 and the like. For example, a thermoplastic resin, a thermosetting resin, an ultraviolet-curable resin, and the like can be used. In view of durability, solvent resistance, and the like, a type of resin cured by crosslinking is preferable, and particularly, an ultraviolet-curable resin that can be cured within a short period of time is preferable. Examples of monomers that can be used for forming the overcoat layer 32 include ethyl (meth)acrylate, ethyl hexyl (meth)acrylate, styrene, methyl styrene, N-vinylpyrrolidone, polymethylolpropane tri(meth)acrylate, hexanediol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate, neopentyl glycol di(meth)acrylate, and the like.

The thickness of the overcoat layer 32 is not particularly limited and may be determined in consideration of the maximum height of the dots 30. The thickness of the overcoat layer 32 may be about 5 to 100 μm, and is preferably 10 to 50 μm and more preferably 20 to 40 μm. The thickness is a distance between a portion without a dot within the dot formation surface of the support and a surface of the overcoat layer facing the dot formation surface.

[Liquid Crystal Layer Film]

In the optical device 10 illustrated in the drawing, the reflection member 20 is constituted with the dot film 24 and the liquid crystal layer film 26 that are laminated.

The liquid crystal layer film 26 is obtained by laminating the cholesteric liquid crystal layer 38 on a support 36.

<Support>

In the liquid crystal layer film 26, the support 36 is the same as the support 28 of the dot film 24.

The support 36 may have an undercoat layer just as the support 28 of the dot film 24.

<Cholesteric Liquid Crystal Layer>

The cholesteric liquid crystal layer 38 is a layer obtained by fixing cholesteric liquid crystalline phases. That is, the cholesteric liquid crystal layer 38 is a layer formed of a liquid crystal material having a cholesteric structure.

The cholesteric liquid crystal layer 38 also selectively reflects infrared and transmits other lights. That is, the cholesteric liquid crystal layer 38 is also a layer obtained by fixing cholesteric liquid crystalline phases having a central wavelength of selective reflection in the infrared range.

As long as both the dot 30 and cholesteric liquid crystal layer 38 selectively reflect infrared, the central wavelength of selective reflection may not be the same for both the dots 30 and cholesteric liquid crystal layer 38. However, it is preferable that the central wavelength of selective reflection is the same for both the dot 30 and cholesteric liquid crystal layer 38. In a case where a difference in the central wavelength of selective reflection between the dot 30 and the cholesteric liquid crystal layer 38 is within a range of ±25 nm, the central wavelength of selective reflection is regarded as being the same for both the dot 30 and cholesteric liquid crystal layer 38.

Furthermore, the cholesteric liquid crystal layer 38 may reflect right circular polarization or left circular polarization. Alternatively, the cholesteric liquid crystal layer 38 may be a layer obtained by laminating a layer reflecting right circular polarization and a layer reflecting left circular polarization.

As described above, the cholesteric liquid crystal layer 38 is a layer obtained by fixing cholesteric liquid crystalline phases.

Accordingly, in a cross section of the cholesteric liquid crystal layer 38 observed with SEM, a streak pattern is observed in which bright portions B and dark portions D resulting from the cholesteric liquid crystalline phases are alternately laminated in a thickness direction (vertical direction in FIG. 1 and FIG. 2).

In the reflection member 20 (laminated film according to the embodiment of the present invention), the bright portions B and the dark portions D in the cross section of the cholesteric liquid crystal layer 38 have a lenticular structure.

That is, in the reflection member 20, the cholesteric liquid crystal layer 38 is a layer which has a cholesteric liquid crystal structure in which the angle formed between the helical axis and the surface of the cholesteric liquid crystal layer 38 continuously changes. In other words, the cholesteric liquid crystal layer 38 is a layer obtained by fixing cholesteric liquid crystalline phases that has a cholesteric liquid crystal structure, in which the cholesteric liquid crystal structure has a streak pattern of the bright portions B and the dark portions D in a cross section of the cholesteric liquid crystal layer 38 observed with SEM, the angle formed between the normal line of a line formed by the bright portions B and the surface of the cholesteric liquid crystal layer 38 periodically changes, and the angle formed between the normal line of a line formed by the dark portions D and the surface of the cholesteric liquid crystal layer 38 periodically changes.

The bright portions and the dark portions of the cholesteric liquid crystal layer 38 (liquid crystal layer film 26) have a lenticular structure in the cross section described above. Therefore, the cholesteric liquid crystal layer 38 has a plurality of regions in which the helical axes of the cholesteric liquid crystalline phases incline different directions.

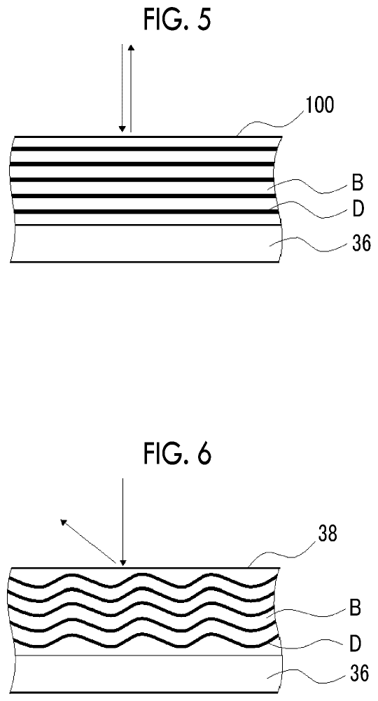

FIG. 5 conceptually shows a cross section of a layer obtained by fixing general cholesteric liquid crystalline phases.

As shown in FIG. 5, generally, in a cross section of a layer 100 obtained by fixing cholesteric liquid crystalline phases disposed on the support 36, a streak pattern formed of the bright portions B and the dark portions D is observed. That is, in the cross section of the layer 100 obtained by fixing cholesteric liquid crystalline phases, a lamellar structure in which the bright portions B and the dark portions D are alternately laminated is observed.

As described above, two bright portions B and two dark portions D correspond to one helical pitch of the cholesteric liquid crystalline phases.

Generally, as shown in FIG. 5, the streak pattern (lamellar structure) of the bright portions B and the dark portions D is formed which is parallel to the surface of the support 36, that is, the surface on which the layer 100 is to be formed. In this aspect, the layer 100 exhibits properties of specular reflection. That is, in a case where light is incident on the layer 100 in the normal direction of the layer 100 formed by fixing cholesteric liquid crystalline phases, the light is reflected in the normal direction but is hardly reflected in an oblique direction, and accordingly, diffuse reflection properties are poor (see the arrows in FIG. 5).

In contrast, in a case where the bright portions B and the dark portions D of the cholesteric liquid crystal layer 38 obtained by fixing cholesteric liquid crystalline phases have a lenticular structure (uneven structure) as in the cross section of the cholesteric liquid crystal layer 38 conceptually shown in FIG. 2 and FIG. 6, and light is incident on the cholesteric liquid crystal layer 38 having the lenticular structure in the normal direction of the cholesteric liquid crystal layer 38, because the layer 38 has regions in which the helical axis of the liquid crystal compound inclines as shown in FIG. 6, some of the incidence rays are reflected in an oblique direction (see the arrows in FIG. 6).

That is, in a case where the bright portions B and the dark portions D of a layer obtained by fixing cholesteric liquid crystalline phases have a lenticular structure, it is possible to realize the cholesteric liquid crystal layer 38 having retroreflection properties and appropriate diffuse reflection properties.

In the cholesteric liquid crystal layer 38, the lenticular structure of the bright portions B and the dark portions D is formed not only in the lateral direction in FIG. 2 (FIG. 6) but also, for example, in a cross section along a direction perpendicular to the paper with FIG. 2. That is, the lenticular structure of the cholesteric liquid crystal layer 38 is two-dimensionally formed along the surface direction of the cholesteric liquid crystal layer 38, and the cholesteric liquid crystal layer 38 is found to have the lenticular structure of the bright portions and the dark portions in cross sections taken along various directions.

Here, the present invention is not limited to the cholesteric liquid crystal layer 38 described above. The cholesteric liquid crystal layer 38 may have a lenticular structure, in which continuous waves run only in one direction, in a cross section. However, in view of retroreflection properties and diffuse reflection properties, it is preferable that the cholesteric liquid crystal layer 38 is found to have the lenticular structure of the bright portions and the dark portions in cross sections taken along various directions as described above.

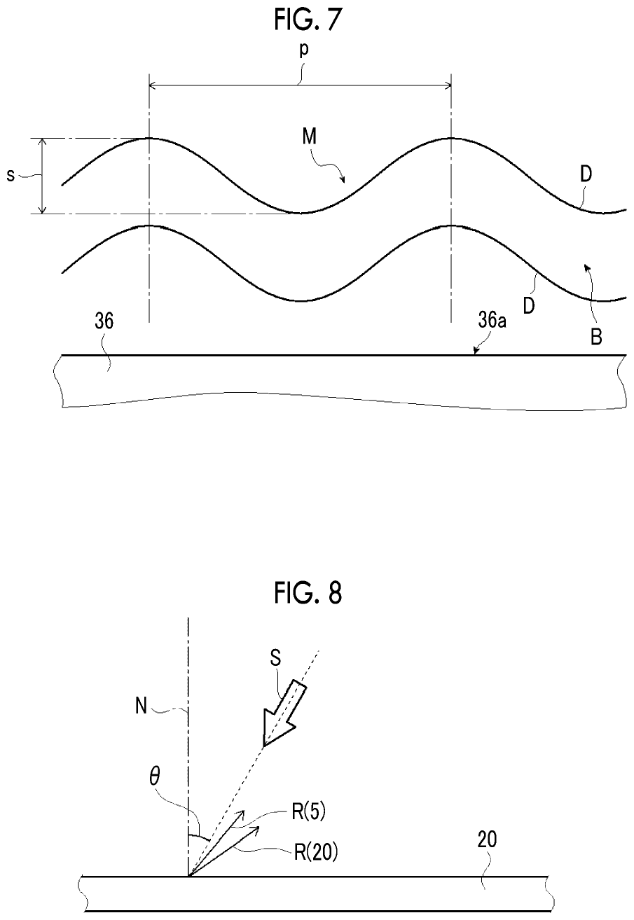

In the cholesteric liquid crystal layer 38 having the lenticular structure formed of the bright portions B and the dark portions D, as being conceptually shown in FIG. 7, in a continuous line formed of the bright portions B or the dark portions D in the streak pattern formed of the bright portions B and the dark portions D, a plurality of peaks (top portions) and valleys (bottom portions) are identified in which an angle of inclination of the cholesteric liquid crystal layer 38 in the support 36 becomes 0° with respect to a formation surface 36a.

In view of obtaining retroreflection properties and appropriate diffuse reflection properties and the like, it is preferable that the cholesteric liquid crystal layer 38 has a plurality of regions M where an angle formed between the continuous line, which is formed of the bright portions B or the dark portions D interposed between the adjacent peak and valley, and the formation surface 36a is equal to or greater than 5°.

For the same reason as described above, in the cholesteric liquid crystal layer 38, an average inter-peak distance p (period p of a wave) in the lenticular structure of the bright portions B and the dark portions D is preferably 1 to 50 μm.

Herein, an angle formed between a differential line of the continuous line, which is formed of the bright portions B or the dark portions D in the lenticular structure of the cholesteric liquid crystal layer 38, and the normal direction of the cholesteric liquid crystal layer 38 is adopted as an angle of inclination.

In a case where standard deviations of angles of inclination are calculated for the continuous lines of the bright portions B or the dark portions D that present within a range of 1 μm from two surfaces (main surfaces) in the thickness direction, the largest standard deviation is represented by a, and the second largest standard deviation is represented by β, it is preferable that the cholesteric liquid crystal layer 38 satisfies the following Expression 1 and Expression 2.

α/β≥1.2 Expression 1

α≥2° Expression 2

It is preferable that the cholesteric liquid crystal layer 38 satisfies the above expressions, because then retroreflection properties, appropriate diffuse reflection properties, and the like are obtained.

<Method for Forming Cholesteric Liquid Crystal Layer>

As described above, the cholesteric liquid crystal layer 38 is a layer obtained by fixing cholesteric liquid crystalline phases.

As the liquid crystal compound forming the cholesteric liquid crystal layer 38, the same compound as the liquid crystal compound forming the dots 30, and preferably the same compound as the polymerizable liquid crystal compound forming the dots 30 can be used.

Accordingly, just as the dots 30, the cholesteric liquid crystal layer 38 may be formed by preparing a liquid crystal composition containing a liquid crystal compound such that cholesteric liquid crystalline phases are fixed which have a helical pitch matching with the corresponding wavelength range and a twisted direction of a helix matching with the circular polarization to be reflexed.

For example, in order to form the cholesteric liquid crystal layer 38, a liquid crystal composition (coating solution) is prepared.

Then, a surface of the support 36 is evenly (uniformly) coated with the liquid crystal composition for forming the cholesteric liquid crystal layer 38 and dried. Furthermore, as in the process of forming the dots 30, the molecules of the liquid crystal compound are aligned in a state of cholesteric liquid crystalline phases, and then the liquid crystal composition is cured, thereby forming the cholesteric liquid crystal layer 38. For coating the support with the liquid crystal composition, it is possible to use all the known methods such as bar coating and spin coating that can evenly coat a sheet-like substance with a liquid.

Generally, a layer obtained by fixing cholesteric liquid crystalline phases is formed by performing a rubbing treatment on the support 36, that is, a surface on which a layer is to be formed, such that anchoring force is applied thereto.

In contrast, the cholesteric liquid crystal layer 38 having a lenticular structure formed of the bright portions B and the dark portions D can be formed without applying anchoring force or by applying weak anchoring force to the support 36 (and the undercoat layer thereof). For example, the cholesteric liquid crystal layer 38 having the preferred lenticular structure described above can be formed without performing a rubbing treatment on a surface (support 36 or the undercoat layer thereof) on which the cholesteric liquid crystal layer 38 is to be formed or by performing a weak rubbing treatment such that appropriate anchoring force is applied thereto.

At the time of forming the cholesteric liquid crystal layer 38 having the lenticular structure formed of the bright portions B and the dark portions D, it is preferable to add a component applying polar angle-restricting force such as a surfactant to the liquid crystal composition for forming the cholesteric liquid crystal layer 38 such that polar angle-restricting force is applied to the side of an air interface of the liquid crystal composition with which the support 36 is coated. As the component applying polar angle-restricting force such as a surfactant, the surfactant described above and the like can be used.

That is, presumably, in a case where the support 36 does not have anchoring force or in a case where support 36 has weak anchoring force, at the moment when the support 36 is just coated with the liquid crystal composition, because the force that restricts the direction of polar angle of liquid crystal molecules does not work on the interface of the liquid crystal composition on the side of the support 36, the liquid crystal molecules in the liquid crystal composition may irregularly (randomly) incline depending on the location. In other words, presumably, in the liquid crystal composition, liquid crystal molecules that are nearly in a horizontal alignment state and liquid crystal molecules that are nearly in a vertical alignment state are irregularly present depending on the location.

In contrast, on the side of the air interface of the liquid crystal composition, due to component applying polar angle-restricting force, the movement of the liquid crystal molecules in the direction of polar angle is restricted, and the liquid crystal molecules are horizontally aligned.

In the process of forming the cholesteric liquid crystal layer 38, then, the liquid crystals are caused to shift to the state of cholesteric phase by means of heating and the like. That is, in a case where the liquid crystals shift to the state of a cholesteric phase, the liquid crystals start to be twisted. At this time, in a case where the liquid crystal composition contains the component applying polar angle-restricting force, as soon as the liquid crystals start to be twisted, a state where the slope of the liquid crystal molecules varies between the side of the support 36 and the side of the air interface is propagated. Presumably, for this reason, the liquid crystals may be twisted while forming a lenticular structure.

That is, in a case where the support 36 does not have anchoring force or has weak anchoring force, and the liquid crystal composition contains the anchoring force-applying component, in the liquid crystal composition, the polar angle-restricting force is appropriately balanced between the interface on the side of the support 36 and the side of the air interface, and accordingly, the cholesteric liquid crystal layer 38 having a lenticular structure can be formed.

The method for forming the cholesteric liquid crystal layer is not limited to the above. Presumably, by appropriately changing the balance of polar angle-restricting force between the side of the air interface and the side of the support, the cholesteric liquid crystal layer 38 having the same lenticular structure as described above could be formed. For example, presumably, by performing an appropriate rubbing treatment on the support 36 so as to weaken the polar angle-restricting force of the side of the support 36 and controlling the amount of surfactants added to the liquid crystal composition so as to weaken the polar angle-restricting force of the side of the air interface, the same lenticular structure and the same optical performance as those described above could be obtained.

The thickness of the cholesteric liquid crystal layer 38 is not particularly limited, and may be appropriately set according to the type of the liquid crystal compound forming the cholesteric liquid crystal layer 38, the state of the lenticular structure, and the like. In view of obtaining the cholesteric liquid crystal layer 38 having excellent retroreflection properties and excellent diffuse reflection properties, the thickness of the cholesteric liquid crystal layer 38 is preferably 0.5 to 30 μm, and more preferably 3 to 10 μm.

The thickness of the cholesteric liquid crystal layer 38 may be measured by known methods using a laser microscope for measuring film thickness (measurement of film thickness by using a laser microscope).

As described above, the dot film 24 which includes two-dimensionally arranged dots 30 and the liquid crystal layer film 26 which includes the cholesteric liquid crystal layer 38 having a lenticular structure formed of the bright portions B and the dark portions D have retroreflection properties and appropriate diffuse reflection properties. That is, the reflection member 20 obtained by laminating the dot film 24 and the liquid crystal layer film 26 has excellent retroreflection properties and appropriate diffuse reflection properties. Accordingly, in a case where the optical device 10 according to the embodiment of the present invention using the reflection member 20 is used, for example, in a motion capture device and the like, it is possible to suitably detect the shape, the depth, and the motion of an object such as a person's hand present between the base 12 and the reflection member 20.

Furthermore, the supports 28 and 36 are preferably transparent, both the dot 30 in the dot film 24 and cholesteric liquid crystal layer 38 of the liquid crystal layer film 26 only reflect infrared and transmit other lights. Accordingly, the reflection member 20 has excellent transparency, and even though the optical device 10 according to the embodiment of the present invention is used by placing the reflection member 20, for example, on a transparent table and the like, it is possible to suitably detect the shape, the depth, and the motion of an object such as a person's hand present between the base 12 and the reflection member 20 while utilizing the transparency of the table.

In the optical device 10 according to the embodiment of the present invention, it is preferable that the reflection member 20 (laminated film according to the embodiment of the present invention) has the following infrared reflection characteristics conceptually illustrated in FIG. 8.

Assume that the infrared radiated from the light source 14 is incident on the reflection member 20 along a direction S (broken line, 0=30°) inclining 30° away from a normal line N (dashed line) of the reflection member 20. At this time, in a plane including the normal line N and the direction S, a reflectivity in a direction inclining 5° toward the reflection member 20 from the direction S is represented by R(5), and a reflectivity in a direction inclining 20° toward the reflection member 20 from the direction S is represented by R(20).

At this time, it is preferable that the reflection member 20 has infrared reflection properties satisfying the following Expression 3 and Expression 4.

R(5)≥1% Expression 3

R(20)/R(5)≥0.05 Expression 4

The reflectivity mentioned herein is a relative reflectivity determined on the assumption that a reflectivity of a standard white plate is 100%. Furthermore, the reflectivity is measured at the peak wavelength of the light source 14.

That is, provided that R(5) is a reflectivity corresponding to reflection, that is, retroreflection occurring along a direction inclining 5° away from an incidence direction of infrared inclining 30° away from the normal line N, and R(20) is a reflectivity corresponding to diffuse reflection occurring in a direction inclining 20° away from the incidence direction of the infrared, it is preferable that the reflection member 20 has retroreflection properties and appropriate diffuse reflection properties in which R(5) is equal to or higher than 1% and R(20) is equal to or higher than 5% of retroreflection.

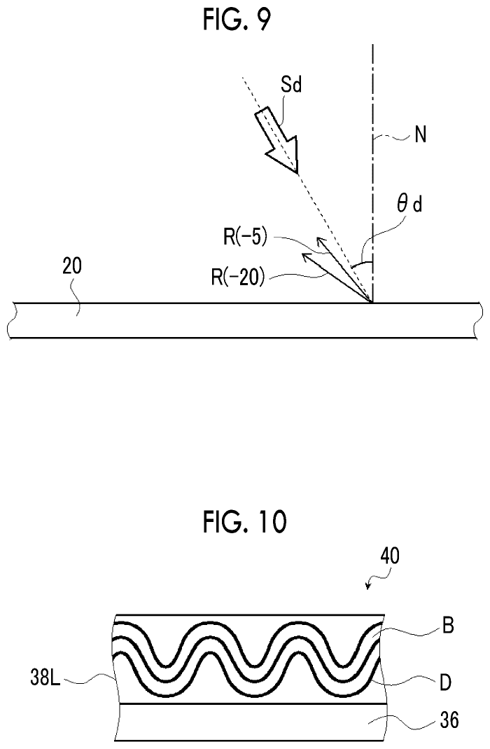

It is more preferable that the reflection member 20 has the following infrared reflection characteristics conceptually illustrated in FIG. 9.

Assume that the infrared radiated from the light source 14 is incident on the reflection member 20 along a direction Sd (broken line, θd=30°) inclining 30° away from a normal line N (dashed line) of the reflection member 20. The direction Sd is a direction different from the direction S shown in FIG. 8.

At this time, in a plane including the normal line N and the direction Sd, a reflectivity in a direction inclining 5° toward the reflection member 20 from the direction Sd is represented by R(−5), and a reflectivity in a direction inclining 20° toward the reflection member 20 from the direction Sd is represented by R(−20).

At this time, it is more preferable that the reflection member 20 has infrared reflection properties satisfying the following Expression 5 and Expression 6.

0.85≤R(5)/R(−5)≥1.15 Expression 5

R(−20)/R(−5)≥0.05 Expression 6

That is, provided that R(−5) is a reflectivity corresponding to reflection, that is, retroreflection occurring along a direction inclining 5° from an incidence direction Sd of infrared that is different from the direction S and inclines 30° from the normal line N, and R(−20) is a reflectivity corresponding to diffuse reflection occurring in a direction inclining 20° from the incidence direction of the infrared, it is more preferable that the reflection member 20 has retroreflection properties and appropriate diffuse reflection properties in which R(−5) is the same as the reflectivity obtained in a case where the infrared is incident along the direction S, and R(−20) is equal to or higher than 5% of retroreflection.

The haze of the reflection member 20 is not particularly limited but is preferably low.

Specifically, the haze of the reflection member is preferably equal to or lower than 10%, and more preferably equal to or lower than 5%.

The reflection member 20 shown in FIG. 1 and FIG. 2 has both the dot film 24, in which dots 30 obtained by fixing cholesteric liquid crystalline phases are two-dimensionally arranged, and liquid crystal layer film 26 having the cholesteric liquid crystal layer 38, which is obtained by fixing cholesteric liquid crystalline phases and has a lenticular structure formed of the bright portions B and the dark portions D resulting from the cholesteric liquid crystalline phases.

However, the reflection member in the optical device according to the embodiment of the present invention is not limited to the constitution in which the reflection member has both the dot film 24 and liquid crystal layer film 26. That is, in the optical device according to the embodiment of the present invention, the reflection member may be constituted only with the dot film 24 or constituted only with the liquid crystal layer film 26.

In view of obtaining excellent retroreflection properties and appropriate diffuse reflection properties and the like, it is preferable that the reflection member has both the dot film 24 and liquid crystal layer film 26.

In a case where the reflection member has only one sheet of film obtained by fixing cholesteric liquid crystalline phases as in a case where the reflection member is constituted only with the dot film 24 or constituted only with the liquid crystal layer film 26, the haze of the reflection member is preferably equal to or lower than 5%, and more preferably equal to or lower than 2%.

Furthermore, in a case where the reflection member has only the liquid crystal layer film 26 including the cholesteric liquid crystal layer 38 which is obtained by fixing cholesteric liquid crystalline phases and has a lenticular structure formed of the bright portions B and the dark portions D resulting from the cholesteric liquid crystalline phases, it is preferable that the lenticular structure of the bright portions B and the dark portions D in a cholesteric liquid crystal layer 38L is much larger as in a reflection member 40 conceptually shown in FIG. 10.

Specifically, in the lenticular structure of the bright portions B and the dark portions D, it is preferable that an inter-peak distance p is short and an amplitude s is large (see FIG. 7).

At the time of forming the cholesteric liquid crystal layer 38L having the large lenticular structure described above, it is preferable to use a liquid crystal compound represented by Formula (I) as a liquid crystal compound forming the cholesteric liquid crystal layer 38L.

Particularly, it is preferable to form the cholesteric liquid crystal layer 38L by coating the support 36 with a liquid crystal composition, which contains the liquid crystal compound represented by Formula (I) and forms the cholesteric liquid crystal layer, then performing a heating treatment for making the liquid crystal compound into cholesteric liquid crystalline phases, and then performing a cooling treatment or a heating treatment for increasing helical twisting power of a chiral agent.

Provided that a number, which is obtained by dividing the number of trans-1,4-cyclohexylene groups represented by A that may have a substituent by m, is mc, as the liquid crystal compound represented by Formula (I), in view of further improving the diffuse reflection properties of the cholesteric liquid crystal layer 38, a liquid crystal compound satisfying mc>0.1 is preferable, and a liquid crystal compound satisfying 0.4≤mc≤0.8 is more preferable.

mc is a number expressed by the following calculation formula.

mc=(number of trans-1,4-cyclohexylene groups represented by A that may have a substituent)÷m

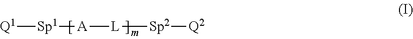

In the formula, A represents a phenylene group which may have a substituent or a trans-1,4-cyclohexylene group which may have a substituent, at least one of A's represents by a trans-1,4-cyclohexylene group which may have a substituent,

L represents a single bond or a linking group selected from the group consisting of —CH₂O—, —OCH₂—, —(CH₂)₂OC(═O)—, —C(═O)O(CH₂)₂—, —C(═O)O—, —OC(═O)—, —OC(═O)O—, —CH═N—N═CH—, —CH═CH—, —C≡C—, —NHC(═O)—, —C(═O)NH—, —CH═N—, —N═CH—, —CH═CH—C(═O)O—, and —OC(═O)—CH═CH—,

m represents an integer of 3 to 12,

Sp¹ and Sp² each independently represent a single bond or a linking group selected from the group consisting of a linear or branched alkylene group having 1 to 20 carbon atoms and a group obtained in a case where one —CH₂— group or two or more —CH₂— groups in a linear or branched alkylene group having 1 to 20 carbon atoms are substituted with —O—, —S—, —NH—, —N(CH₃)—, —C(═O)—, —OC(═O)—, or —C(═O)O—,

Q¹ and Q² each independently represent a hydrogen atom or a polymerizable group selected from the group consisting of groups represented by Formula (Q-1) to Formula (Q-5), at least one of Q¹ or Q² represents a polymerizable group; and

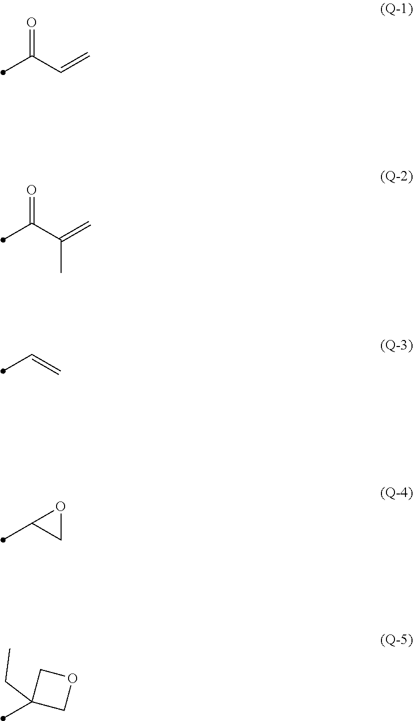

A represents a phenylene group which may have a substituent or a trans-1,4-cyclohexylene group which may have a substituent. In the present specification, as a phenylene group, a 1,4-phenylene group is preferable.

At least one of A's represents a trans-1,4-cyclohexylene group which may have a substituent.

m pieces of A may be the same as or different from each other.

m represents an integer of 3 to 12. m is preferably an integer of 3 to 9, more preferably an integer of 3 to 7, and even more preferably an integer of 3 to 5.

The substituent that the phenylene group and the trans-1,4-cyclohexylene group in Formula (I) may have is not particularly limited, and examples thereof include substituents selected from the group consisting of an alkyl group, a cycloalkyl group, an alkoxy group, an alkylether group, an amide group, an amino group, a halogen atom, and groups constituted with a combination of two or more substituents described above. Examples of the substituent also include a substituent represented by —C(═O)—X³-Sp³-Q³ which will be described later. The phenylene group and the trans-1,4-cyclohexylene group may have 1 to 4 substituents. In a case where the phenylene group and the trans-1,4-cyclohexylene group have 2 or more substituents, 2 or more of the substituents may be the same as or different from each other.

In the present specification, the alkyl group may be linear or branched. The number of carbon atoms in the alkyl group is preferably 1 to 30, more preferably 1 to 10, and even more preferably 1 to 6. Examples of the alkyl group include a methyl group, an ethyl group, a n-propyl group, an isopropyl group, a n-butyl group, an isobutyl group, a sec-butyl group, a tert-butyl group, a n-pentyl group, an isopentyl group, a neopentyl group, a 1,1-dimethylpropyl group, a n-hexyl group, an isohexyl group, a heptyl group, an octyl group, a nonyl group, a decyl group, an undecyl group, a dodecyl group, and the like. The description relating to the above alkyl group is also applied to an alkyl group in the alkoxy group. In the present specification, specific examples of the alkylene group include divalent groups obtained by removing any one hydrogen atom from each of the alkyl groups exemplified above. Examples of the halogen atom include a fluorine atom, a chlorine atom, a bromine atom, and an iodine atom.

In the present specification, the number of carbon atoms in the cycloalkyl group is preferably equal to or greater than 3, and more preferably equal to or greater than 5. Furthermore, the number of carbon atoms in the cycloalkyl group is preferably equal to or smaller than 20, more preferably equal to or smaller than 10, even more preferably equal to or smaller than 8, and particularly preferably equal to or smaller than 6. Examples of the cycloalkyl group include a cyclopropyl group, a cyclobutyl group, a cyclopentyl group, a cyclohexyl group, a cycloheptyl group, a cyclooctyl group, and the like.

As the substituent that the phenylene group and the trans-1,4-cyclohexylene group may have, a substituent selected from the group consisting of an alkyl group, an alkoxy group, and —C(═O)—X³-Sp³-Q³ is preferable. X³ represents a single bond, —O—, —N(Sp⁴-Q⁴)-, or a nitrogen atom forming a ring structure together with Q³ and Sp³. Sp³ and Sp⁴ each independently represent a single bond or a linking group selected from the group consisting of a linear or branched alkylene group having 1 to 20 carbon atoms, and a group obtained in a case where one —CH₂— group or two or more —CH₂— groups in a linear or branched alkylene group having 1 to 20 carbon atoms are substituted with —O—, —S—, —NH—, —N(CH₃)—, —C(═O)—, —OC(═O)—, or —C(═O)O—.

Q³ and Q⁴ each independently represent a hydrogen atom, a cycloalkyl group, a group obtained in a case where one —CH₂— group or two or more —CH₂— groups in a cycloalkyl group are substituted with —O—, —S—, —NH—, —N(CH₃)—, —C(═O)—, —OC(═O)—, or —C(═O)O—, or any polymerizable group selected from the group consisting of groups represented by Formula (Q-1) to Formula (Q-5).

Specifically, examples of the group, which is obtained in a case where one —CH₂— group or two or more —CH₂— groups in a cycloalkyl group are substituted with —O—, —S—, —NH—, —N(CH₃)—, —C(═O)—, —OC(═O)—, or —C(═O)O—, include a tetrahydrofuranyl group, a pyrrolidinyl group, an imidazolidinyl group, a pyrazolidinyl group, a piperidyl group, a piperazinyl group, a morphornyl group, and the like. Among these, a tetrahydrofuranyl group is preferable, and a 2-tetrahydrofuranyl group is more preferable.

In Formula (I), L represents a single bond or a linking group selected from the group consisting of —CH₂O—, —OCH₂—, —(CH₂)₂OC(═O)—, —C(═O)O(CH₂)₂—, —C(═O)O—, —OC(═O)—, —OC(═O)O—, —CH═CH—C(═O)O—, and —OC(═O)—CH═CH—. L is preferably —C(═O)O— or —OC(═O)—. m pieces of L's may be the same as or different from each other.

Sp¹ and Sp² each independently represent a single bond or a linking group selected from the group consisting of a linear or branched alkylene group having 1 to 20 carbon atoms and a group obtained in a case where one —CH₂— group or two or more —CH₂— groups in a linear or branched alkylene group having 1 to 20 carbon atoms are substituted with —O—, —S—, —NH—, —N(CH₃)—, —C(═O)—, —OC(═O)—, or —C(═O)O—. Sp¹ and Sp² preferably each independently represent a linking group constituted with one group or a combination of two or more groups selected from the group consisting of a linear alkylene group having 1 to 10 carbon atoms, in which a linking group selected from the group consisting of —O—, —OC(═O)—, and —C(═O)O— is bonded to both terminals thereof, —OC(═O)—, —C(═O)O—, —O—, and a linear alkylene group having 1 to 10 carbon atoms, and more preferably each independently represent a linear alkylene group having 1 to 10 carbon atoms in which —O— is bonded to both terminals thereof.

Q¹ and Q² each independently represent a hydrogen atom or a polymerizable group selected from the group consisting of Formula (Q-1) to Formula (Q-5). Here, any one of Q¹ or Q² represents a polymerizable group.

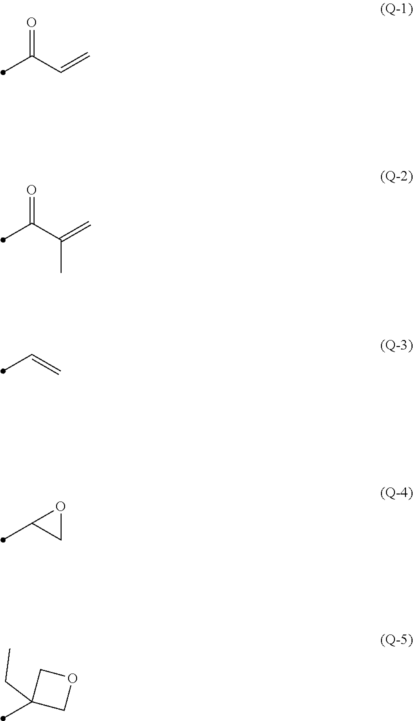

As the polymerizable group, an acryloyl group (Formula (Q-1)) or a methacryloyl group (Formula (Q-2)) is preferable.

Specifically, examples of the liquid crystal compound described above include a liquid crystal compound represented by Formula (I-11), a liquid crystal compound represented by Formula (I-21), and a liquid crystal compound represented by Formula (I-31).

Liquid Crystal Compound Represented by Formula (I-11)

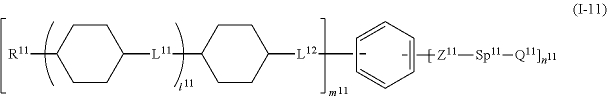

In the formula, R¹¹ represents a hydrogen atom, a linear or branched alkyl group having 1 to 12 carbon atoms, or —Z¹²-Sp¹²-Q¹²,

L¹¹ represents a single bond, —C(═O)O—, or —O(C═O)—,

L¹² represents —C(═O)O—, —OC(═O)—, or —CONR²—,

R² represents a hydrogen atom or an alkyl group having 1 to 3 carbon atoms,

Z¹¹ and Z¹² each independently represent a single bond, —O—, —NH—, —N(CH₃)—, —S—, —C(═O)O—, —OC(═O)—, —OC(═O)O—, or —C(═O)NR¹²—,

R¹² represents a hydrogen atom or -Sp¹²-Q¹²,

Sp¹¹ and Sp¹² each independently represent a single bond, a linear or branched alkylene group having 1 to 12 carbon atoms that may be substituted Q¹¹, or a linking group obtained in a case where one or more —CH₂— groups in a linear or branched alkylene group having 1 to 12 carbon atoms that may be substituted with Q¹¹ are substituted with —O—, —S—, —NH—, —N(Q¹¹)-, or —C(═O)—,

Q¹¹ represents a hydrogen atom, a cycloalkyl group, a group obtained in a case where one —CH₂— group or two or more —CH₂— groups in a cycloalkyl group are substituted with —O—, —S—, —NH—, —N(CH₃)—, —C(═O)—, —OC(═O)—, or —C(═O)O—, or a polymerizable group selected from the group consisting of groups represented by Formula (Q-1) to Formula (Q-5),

Q¹² represents a hydrogen atom or a polymerizable group selected from the group consisting of groups represented by Formula (Q-1) to Formula (Q-5),

I¹¹ represents an integer of 0 to 2,

m¹¹ represents an integer of 1 or 2,

n¹¹ represents an integer of 1 to 3, and

a plurality of W¹¹'s, a plurality of L¹¹'s, a plurality of L¹²'s, a plurality of I¹¹'s, a plurality of Z¹¹'s, a plurality of Sp¹¹'s, and a plurality of Q¹¹'s may be the same as or different from each other respectively.

The liquid crystal compound represented by Formula (I-11) contains, as R¹¹, at least one —Z¹²-Sp¹²-Q¹² group in which Q¹² is a polymerizable group selected from the group consisting of groups represented by Formula (Q-1) to Formula (Q-5).

The liquid crystal compound represented by Formula (I-11) is preferably —Z¹¹-Sp¹¹-Q¹¹ in which Z¹¹ is —C(═O)O— or —C(═O)NR¹²—, and Q¹¹ is a polymerizable group selected from the group consisting of groups represented by Formula (Q-1) to Formula (Q-5). Furthermore, in the liquid crystal compound represented by Formula (I-11), R¹¹ is preferably —Z¹²-Sp¹²-Q¹² in which Z¹² represents —C(═O)O— or —C(═O)NR¹²—, and Q¹² is a polymerizable group selected from the group consisting of groups represented by Formula (Q-1) to Formula (Q-5).

All of the 1,4-cyclohexylene groups contained in the liquid crystal compound represented by Formula (I-11) are trans-1,4-cyclohexylene groups.

In a suitable aspect, examples of the liquid crystal compound represented by Formula (I-11) include a compound in which L¹¹ is a single bond, I¹¹ is 1 (dicyclohexyl group), and Q¹¹ is a polymerizable group selected from the group consisting of groups represented by Formula (Q-1) to Formula (Q-5).

In another suitable aspect, examples of the liquid crystal compound represented by Formula (I-11) include a compound in which m¹¹ is 2, I¹¹ is 0, both of R¹¹'s represent —Z¹²-Sp¹²-Q¹², and Q¹² is a polymerizable group selected from the group consisting of groups represented by Formula (Q-1) to Formula (Q-5).

Liquid Crystal Compound Represented by Formula (I-21)

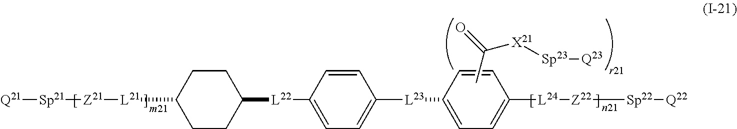

In the formula, Z²¹ and Z²² each independently represent a trans-1,4-cyclohexylene group which may have a substituent or a phenylene group which may have a substituent, the aforementioned substituents each independently represent 1 to 4 substituents selected from the group consisting of —CO—X²¹-Sp²³-Q²³, an alkyl group, and an alkoxy group,

m21 represents an integer of 1 or 2, n21 represents an integer of 0 or 1,

in a case where m21 represents 2, n21 represents 0,

in a case where m21 represents 2, two Z²¹'s may be the same as or different from each other,

at least one of Z²¹ or Z²² represents a phenylene group which may have a substituent,

L²¹, L²², L²³, and L²⁴ each independently represent a single bond or a linking group selected from the group consisting of —CH₂O—, —OCH₂—, —(CH₂)₂OC(═O)—, —C(═O)O(CH₂)₂—, —C(═O)O—, —OC(═O)—, —OC(═O)O—, —CH═CH—C(═O)O—, and —OC(═O)—CH═CH—,

X²¹ represents —O—, —S—, —N(Sp²⁵-Q²⁵)-, or a nitrogen atom forming a ring structure together with Q²³ and Sp²³,

r²¹ represents an integer of 1 to 4,

Sp²¹, Sp²², Sp²³, and Sp²⁵ each independently represent a single bond or a linking group selected from the group consisting of a linear or branched alkylene group having 1 to 20 carbon atoms and a group obtained in a case where one —CH₂— group or two or more —CH₂— groups in a linear or branched alkylene group having 1 to 20 carbon atoms are substituted with —O—, —S—, —NH—, —N(CH₃)—, —C(═O)—, —OC(═O)—, or —C(═O)O—,

Q²¹ and Q²² each independently represent any polymerizable group selected from the group consisting of groups represented by Formula (Q-1) to Formula (Q-5),

Q²³ represents a hydrogen atom, a cycloalkyl group, a group obtained in a case where one —CH₂— group or two or more —CH₂— groups in a cycloalkyl group are substituted with —O—, —S—, —NH—, —N(CH₃)—, —C(═O)—, —OC(═O)—, or —C(═O)O—, any polymerizable group selected from the group consisting of groups represented by Formula (Q-1) to Formula (Q-5), or a single bond in a case where X²¹ is a nitrogen atom forming a ring structure together with the Q²³ and Sp²³,

Q²⁵ represents a hydrogen atom, a cycloalkyl group, a group obtained in a case where one —CH₂— group or two or more —CH₂— groups in a cycloalkyl group are substituted with —O—, —S—, —NH—, —N(CH₃)—, —C(═O)—, —OC(═O)—, or —C(═O)O—, or any polymerizable group selected from the group consisting of groups represented by Formula (Q-1) to Formula (Q-5), and in a case where Sp²⁵ is a single bond, Q²⁵ is not a hydrogen atom.

It is preferable that the liquid crystal compound represented by Formula (I-21) is a structure in which a 1,4-phenylene group and a trans-1,4-cyclohexylene group alternate. For example, the liquid crystal compound represented by Formula (I-21) is preferably a structure in which m21 is 2, n21 is 0, and Z²¹ is a trans-1,4-cyclohexylene group that may have a substituent or an arylene group that may have a substituent from the Q²¹ side, or a structure in which m21 is 1, n21 is 1, Z²¹ is an arylene group that may have a substituent, and Z²² is an arylene group that may have a substituent.

Liquid Crystal Compound Represented by Formula (I-31);

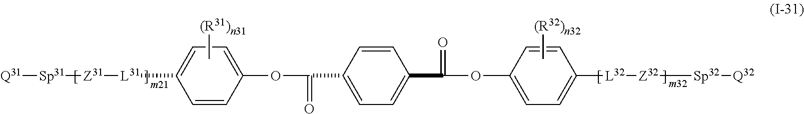

In the formula, R³¹ and R³² each independently represent a group selected from the group consisting of an alkyl group, an alkoxy group, and —C(═O)—X³¹-Sp³³-Q³³,

n31 and n32 each independently represent an integer of 0 to 4,

X³¹ represents —O—, —S—, —N(Sp³⁴-Q³⁴)-, or a nitrogen atom forming a ring structure together with Q³³ and Sp³³,

Z³¹ represents a phenylene group which may have a substituent,

Z³² represents a trans-1,4-cyclohexylene group which may have a substituent or a phenylene group which may have a substituent,

each of the aforementioned substituents each independently represent 1 to 4 substituents selected from the group consisting of an alkyl group, an alkoxy group, and —C(═O)—X³¹-Sp³³-Q³³,

m31 represents an integer of 1 or 2, m32 represents an integer of 0 to 2,

in a case where both the m31 and m32 represent 2, two Z³¹'s and two Z³²'s may be the same as or different from each other respectively,

L³¹ and L³² each independently represent a single bond or a linking group selected from the group consisting of —CH₂O—, —OCH₂—, —(CH₂)₂OC(═O)—, —C(═O)O(CH₂)₂—, —C(═O)O—, —OC(═O)—, —OC(═O)O—, —CH═CH—C(═O)O—, and —OC(═O)—CH═CH—,

Sp³¹, Sp³², Sp³³, and Sp³⁴ each independently represent a single bond or a linking group selected from the group consisting of a linear or branched alkylene group having 1 to 20 carbon atoms and a group obtained in a case where one —CH₂— group or two or more —CH₂— groups in a linear or branched alkylene group having 1 to 20 carbon atoms are substituted with —O—, —S—, —NH—, —N(CH₃)—, —C(═O)—, —OC(═O)—, or —C(═O)O—,

Q³¹ and Q³² each independently represent any polymerizable group selected from the group consisting of groups represented by Formula (Q-1) to Formula (Q-5),

Q³³ and Q³⁴ each independently represent a hydrogen atom, a cycloalkyl group, a group obtained in a case where one —CH₂— group or two or more —CH₂— groups in a cycloalkyl group are substituted with —O—, —S—, —NH—, —N(CH₃)—, —C(═O)—, —OC(═O)—, or —C(═O)O—, or any polymerizable group selected from the group consisting of groups represented by Formula (Q-1) to Formula (Q-5), in a case where Q³³ forms a ring structure together with the X³¹ and Sp³³, Q³³ may represent a single bond, and in a case where Sp³⁴ is a single bond, Q³⁴ is not a hydrogen atom.

As the liquid crystal compound represented by Formula (I-31), for example, a compound in which Z³² is a phenylene group and a compound in which m32 is 0 are particularly preferable.

It is also preferable that the compound represented by Formula (I) has a partial structure represented by Formula (H).

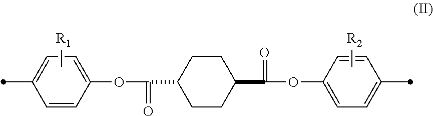

In Formula (II), each of the black circles represents a position where Formula (II) is bonded to another portion of Formula (I). The partial structure represented by Formula (II) may be included in Formula (I) as a portion of a partial structure represented by Formula (III).

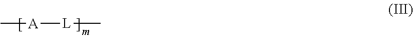

In the formula, R¹ and R² each independently represent a group selected from the group consisting of a hydrogen atom, an alkyl group, an alkoxy group, and a group represented by —C(═O)—X³-Sp³-Q³. X³ represents a single bond, —O—, —S—, —N(Sp⁴-Q⁴)-, or a nitrogen atom forming a ring structure together with Q³ and Sp³. X³ is preferably a single bond or —O—. Each of R¹ and R² is preferably —C(═O)—X³-Sp³-Q³. Furthermore, it is preferable that R¹ and R² are the same as each other. The position where each of R¹ and R² is bonded to a phenylene group is not particularly limited.

Sp³ and Sp⁴ each independently represent a single bond or a linking group selected from the group consisting of a linear or branched alkylene group having 1 to 20 carbon atoms and a group obtained in a case where one —CH₂— group or two or more —CH₂— groups in a linear or branched alkylene group having 1 to 20 carbon atoms are substituted with —O—, —S—, —NH—, —N(CH₃)—, —C(═O)—, —OC(═O)—, or —C(═O)O—. Sp³ and Sp⁴ preferably each independently represent a linear or branched alkylene group having 1 to 10 carbon atoms, more preferably each independently represent a linear alkylene group having 1 to 5 carbon atoms, and even more preferably each independently represent a linear alkylene group having 1 to 3 carbon atoms.

Q³ and Q⁴ each independently represent a hydrogen atom, a cycloalkyl group, a group obtained in a case where one —CH₂— group or two or more —CH₂— groups in a cycloalkyl group are substituted with —O—, —S—, —NH—, —N(CH₃)—, —C(═O)—, —OC(═O)—, or —C(═O)O—, or any polymerizable group selected from the group consisting of groups represented by Formula (Q-1) to Formula (Q-5).

It is also preferable that the compound represented by Formula (I) has a structure represented by Formula (II-2), for example.

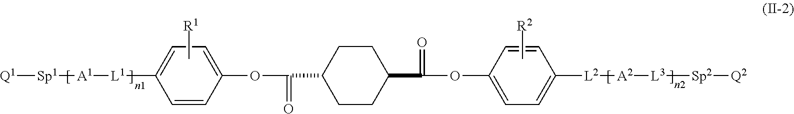

In the formula, A¹ and A² each independently represent a phenylene group which may have a substituent or a trans-1,4-cyclohexylene group which may have a substituent, the aforementioned substituents each independently represent 1 to 4 substituents selected from the group consisting of an alkyl group, an alkoxy group, and —C(═O)—X³-Sp³-Q³,

L¹, L², and L³ each represent a single bond or a linking group selected from the group consisting of —CH₂O—, —OCH₂—, —(CH₂)₂OC(═O)—, —C(═O)O(CH₂)₂—, —C(═O)O—, —OC(═O)—, —OC(═O)O—, —CH═CH—C(═O)O—, and —OC(═O)—CH═CH—,

n1 and n2 each independently represent an integer of 0 to 9, and n1+n2 is equal to or smaller than 9.

Q¹, Q², Sp¹, and Sp² have the same definition as Q¹, Q², Sp¹, and Sp² in Formula (I). X³, Sp³, Q³, R¹, and R² have the same definition as X³, Sp³, Q³, R¹, and R² in Formula (II).

Two or more kinds of liquid crystal compounds may be used in combination.

The liquid crystal compound used in the present invention is described in JP2014-198814A. The following compound represented by Formula (IV), particularly, a polymerizable liquid crystal compound represented by Formula (IV) having one (meth)acrylate group is also suitably used.

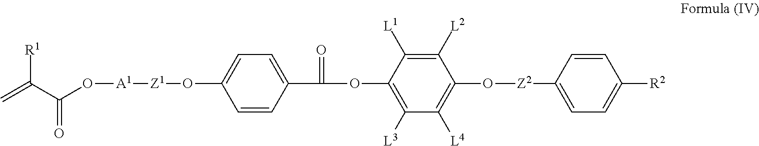

In Formula (IV), A¹ represents an alkylene group having 2 to 18 carbon atoms, one CH₂ group or two or more CH₂ groups not being adjacent to each other in the alkylene group may be substituted with —O—;
Z¹ represents —C(═O)—, —O—C(═O)—, or a single bond;
Z² represents —C(═O)— or —C(═O)—CH═CH—;
R¹ represents a hydrogen atom or a methyl group;
R² represents a hydrogen atom, a halogen atom, a linear alkyl group having 1 to 4 carbon atoms, a methoxy group, an ethoxy group, a phenyl group which may have a substituent, a vinyl group, a formyl group, a nitro group, a cyano group, an acetyl group, an acetoxy group, a N-acetylamide group, an acryloylamino group, a N,N-dimethylamino group, a maleimide group, a methacryloylamino group, an allyloxy group, an allyloxycarbamoyl group, a N-alkyloxycarbamoyl group containing an alkyl group having 1 to 4 carbon atoms, a N-(2-methacryloyloxyethyl)carbamoyloxy group, a N-(2-acryloyloxyethyl)carbamoyloxy group, or a structure represented by Formula (IV-2);

L¹, L², L³, and L⁴ each independently represent an alkyl group having 1 to 4 carbon atoms, an alkoxy group having 1 to 4 carbon atoms, an alkoxycarbonyl group having 2 to 5 carbon atoms, an acyl group having 2 to 4 carbon atoms, a halogen atom, or a hydrogen atom, and at least one of L¹, L², L³, or L⁴ represents a group other than a hydrogen atom.

—Z⁵-T-Sp-P Formula (IV-2)

In Formula (IV-2), P represents an acryl group, a methacryl group, or a hydrogen atom, Z⁵ represents a single bond, —C(═O)O—, —OC(═O)—, —C(═O)NR¹— (R¹ represents a hydrogen atom or a methyl group), —NR¹C(═O)—, —C(═O)S—, or —SC(═O)—, T represents a 1,4-phenylene group, Sp represents a divalent aliphatic group having 1 to 12 carbon atoms that may have a substituent, and one CH₂ group or two or more CH₂ group not being adjacent to each other in the aliphatic group may be substituted with —O—, —S—, —OC(═O)—, —C(═O)O—, or —OCOO—.

The compound represented by Formula (IV) is preferably a compound represented by Formula (V).

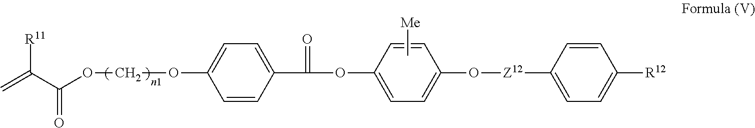

In Formula (V), n1 represents an integer of 3 to 6;

R¹¹ represents a hydrogen atom or a methyl group;

Z¹² represents —C(═O)— or —C(═O)—CH═CH—; and

R¹² represents a hydrogen atom, a linear alkyl group having 1 to 4 carbon atoms, a methoxy group, an ethoxy group, a phenyl group, an acryloylamino group, a methacryloylamino group, an allyloxy group, or a structure represented by Formula (IV-3).

—Z⁵¹-T-Sp-P Formula (IV-3)

In Formula (IV-3), P represents an acryl group or a methacryl group;

Z⁵¹ represents —C(═O)O— or —OC(═O)—; T represents a 1,4-phenylene group; and

Sp represents a divalent aliphatic group having 2 to 6 carbon atoms that may have a substituent. One CH₂ group or two or more CH₂ groups not being adjacent to each other in the aliphatic group may be substituted with —O—, —OC(═O)—, —C(═O)O—, or —OC(═O)O—.

n1 in the above formula represents an integer of 3 to 6, and is preferably 3 or 4.

Z¹² in the above formula represents —C(═O)— or —C(═O)—CH═CH—, and preferably represents —C(═O)—.

R¹² in the above formula represents a hydrogen atom, a linear alkyl group having 1 to 4 carbon atoms, a methoxy group, an ethoxy group, a phenyl group, an acryloylamino group, a methacryloylamino group, an allyloxy group, or a group represented by Formula (IV-3). R¹² preferably represents a methyl group, an ethyl group, a propyl group, a methoxy group, an ethoxy group, a phenyl group, an acryloylamino group, a methacryloylamino group, or a group represented by Formula (IV-3), and more preferably represents a methyl group, an ethyl group, a methoxy group, an ethoxy group, a phenyl group, an acryloylamino group, a methacryloylamino group, or a structure represented by Formula (IV-3).

As the liquid crystal compound used in the present invention, the following compound represented by Formula (VI) described in JP2014-198814A, particularly, a liquid crystal compound represented by Formula (VI) that does not have a (meth)acrylate group is also suitably used.

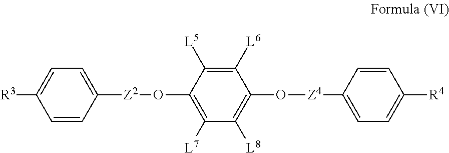

In Formula (VI), Z³ represents —C(═O)— or —CH═CH—C(═O)—;

Z⁴ represents —C(═O)— or —C(═O)—CH═CH—;

R³ and R⁴ each independently represent a hydrogen atom, a halogen atom, a linear alkyl group having 1 to 4 carbon atoms, a methoxy group, an ethoxy group, an aromatic ring which may have a substituent, a cyclohexyl group, a vinyl group, a formyl group, a nitro group, a cyano group, an acetyl group, an acetoxy group, an acryloylamino group, a N,N-dimethylamino group, a maleimide group, a methacryloylamino group, an allyloxy group, an allyloxycarbamoyl group, a N-alkyloxycarbamoyl group containing an alkyl group having to 4 carbon atoms, a N-(2-methacryloyloxyethyl)carbamoyloxy group, a N-(2-acryloyloxyethyl)carbamoyloxy group, or a structure represented by Formula (VI-2);

L⁵, L⁶, L⁷, and L⁸ each independently represent an alkyl group having 1 to 4 carbon atoms, an alkoxy group having 1 to 4 carbon atoms, an alkoxycarbonyl group having 2 to 5 carbon atoms, an acyl group having 2 to 4 carbon atoms, a halogen atom, or a hydrogen atom, and at least one of L⁵, L⁶, L⁷, or L⁸ represents a group other than a hydrogen atom.

—Z⁵-T-Sp-P Formula (VI-2)

In Formula (VI-2), P represents an acryl group, a methacryl group, or a hydrogen atom, Z⁵ represents —C(═O)O—, —OC(═O)—, —C(═O)NR¹ (R¹ represents a hydrogen atom or a methyl group), —NR¹C(═O)—, —C(═O)S—, or —SC(═O)—, T represents 1,4-phenylene, and Sp represents a divalent aliphatic group having 1 to 12 carbon atoms that may have a substituent. Here, one CH₂ group or two or more CH₂ groups not being adjacent to each other in the aliphatic group may be substituted with —O—, —S—, —OC(═O)—, —C(═O)O—, or —OC(═O)O—.

It is preferable that the compound represented by Formula (VI) is the following compound represented by Formula (VII).

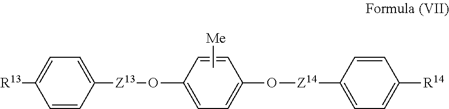

In Formula (VII), Z¹³ represents —C(═O)— or —C(═O)—CH═CH—;

Z¹⁴ represents —C(═O)— or —CH═CH—C(═O)—; and

R¹³ and R¹⁴ each independently represent a hydrogen atom, a linear alkyl group having 1 to 4 carbon atoms, a methoxy group, an ethoxy group, a phenyl group, an acryloylamino group, a methacryloylamino group, an allyloxy group, or a structure represented by Formula (IV-3).

Z¹³ represents —C(═O)— or —C(═O)—CH═CH—, and preferably represents —C(═O)—.

R¹³ and R¹⁴ each independently represent a hydrogen atom, a linear alkyl group having 1 to 4 carbon atoms, a methoxy group, an ethoxy group, a phenyl group, an acryloylamino group, a methacryloylamino group, an allyloxy group, or a structure represented by Formula (IV-3), preferably each independently represent a methyl group, an ethyl group, a propyl group, a methoxy group, an ethoxy group, a phenyl group, an acryloylamino group, a methacryloylamino group, or a structure represented by Formula (IV-3), and even more preferably each independently represent a methyl group, an ethyl group, a methoxy group, an ethoxy group, a phenyl group, an acryloylamino group, a methacryloylamino group, or a structure represented by Formula (IV-3).

As the liquid crystal compound used in the present invention, the following compound represented by Formula (VIII) described in JP2014-198814A, particularly, a polymerizable liquid crystal compound represented by Formula (VIII) having two (meth)acrylate groups is also suitably used.

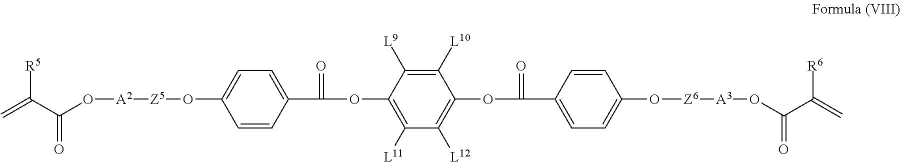

In Formula (VIII), A² and A³ each independently represent an alkylene group having 2 to 18 carbon atoms, one CH₂ group or two or more CH₂ groups not being adjacent to each other in the alkylene group may be substituted with —O—;

Z⁵ represents —C(═O)—, —OC(═O)—, or a single bond;

Z⁶ represents —C(═O)—, —C(═O)O—, or a single bond;

R⁵ and R⁶ each independently represent a hydrogen atom or a methyl group;

L⁹, L¹⁰, L¹¹, and L¹² each independently represent an alkyl group having 1 to 4 carbon atoms, an alkoxy group having 1 to 4 carbon atoms, an alkoxycarbonyl group having 2 to 5 carbon atoms, an acyl group having 2 to 4 carbon atoms, a halogen atom, or a hydrogen atom, and at least one of L⁹, L¹⁰, L¹¹, or L¹² represents a group other than a hydrogen atom.

The compound represented by Formula (VIII) is preferably the following compound represented by Formula (IX).

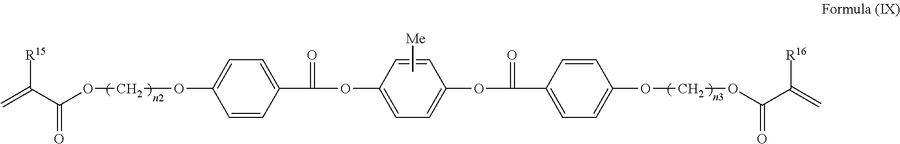

In Formula (IX), n2 and n3 each independently represent an integer of 3 to 6; and

R¹⁵ and R¹⁶ each independently represent a hydrogen atom or a methyl group.

In Formula (IX), n2 and n3 each independently represent an integer of 3 to 6. It is preferable that both the n2 and n3 represent 4.

In Formula (IX), R¹⁵ and R¹⁶ each independently represent a hydrogen atom or a methyl group. It is preferable that both the R¹⁵ and R¹⁶ represent a hydrogen atom.

These liquid crystal compounds can be manufactured by known methods.

As described above, in a case where a reflection member 40 is prepared which is constituted only with a liquid crystal layer film including the cholesteric liquid crystal layer 38L having a large lenticular structure formed of the bright portions B and the dark portions D, it is preferable to form the cholesteric liquid crystal layer 38L by coating the support 36 with a liquid crystal composition forming a cholesteric liquid crystal layer containing the liquid crystal compound represented by Formula (I), then performing a heating treatment such that the liquid crystal compound becomes cholesteric liquid crystalline phases, and then performing a cooling treatment or a heating treatment for increasing helical twisting power of a chiral agent.

Specifically, the support 36 is coated with a liquid crystal composition forming the cholesteric liquid crystal layer 38L as described above, and then the liquid crystal composition with which the support 36 is coated is heated such that the molecules of the liquid crystal compound in the composition are aligned and turn into cholesteric liquid crystalline phases.

In view of manufacturing suitability, the liquid crystalline phase transition temperature of the liquid crystal composition is preferably 10° to 250°, and more preferably 10° to 150°.

Regarding the heating condition, it is preferable that the composition is heated at a temperature of 40° C. to 100° C. and preferably at a temperature of 60° C. to 100° C. for 0.5 to 5 minutes and preferably for 0.5 to 2 minutes.

After the liquid crystal compound turns into the cholesteric liquid crystalline phases by heating the liquid crystal composition, in order to increase the helical twisting power of the chiral agent contained in the liquid crystal composition, the composition is cooled or heated, thereby forming the cholesteric liquid crystal layer 38L. That is, in order to increase the helical twisting power (HTP) of the chiral agent contained in the liquid crystal composition formed on the support 36, a cooling treatment or a heating treatment is performed on the coating layer.

In a case where the cooling treatment or a heating treatment is performed on the coating layer, the helical twisting power of the chiral agent increases. Therefore, the molecules of the liquid crystal compound are further twisted, and accordingly, the alignment of the cholesteric liquid crystalline phases (slope of the helical axes) changes. As a result, the bright portions B and the dark portions D parallel to the support 36 (surface on which the cholesteric liquid crystal layer 38L is formed) change, and the cholesteric liquid crystal layer 38L (layer of the composition in the state of cholesteric liquid crystalline phases) having the bright portions B and the dark portions D forming a large lenticular structure (uneven structure) is formed.

At the time of cooling the liquid crystal composition, in view of further improving the diffuse reflection properties of the cholesteric liquid crystal layer 38L, it is preferable to cool the composition such that the temperature of the composition is reduced by equal to or greater than 30° C. Particularly, in view of further improving the effect described above, the composition is preferably cooled such that the temperature thereof is reduced by equal to or greater than 40° C., and more preferably cooled such that the temperature thereof is reduced by equal to or greater than 50° C. The upper limit of a range of temperature reduced by the cooling treatment is not particularly limited, but is generally about 70° C.

Provided that the temperature of the composition that is in the state of cholesteric liquid crystalline phases before cooling is T° C., the cooling treatment is in other words a process of cooling the composition such that the temperature thereof becomes equal to or lower than T−30° C.

The cooling method is not particularly limited, and examples thereof include a method of allowing the substrate, on which the composition is disposed, to stand still at an atmosphere with a specific temperature.

In the cooling treatment, a cooling rate is not particularly limited. However, in order to suitably form the lenticular structure of the bright portions B and the dark portions D of the cholesteric liquid crystalline phases or in order to suitably form unevenness on the surface of a reflection layer which will be described later, it is preferable that the cooling rate is set to be within a certain range.

Specifically, the upper limit of the cooling rate in the cooling treatment is preferably set to be equal to or higher than 1° C. per second, and more preferably set to be equal to or higher than 2° C. per second.

In a case where the liquid crystal compound has a polymerizable group, after the cooling treatment or the heating treatment is performed, a curing treatment may be performed on the liquid crystal composition on the support 36 such that the cholesteric liquid crystalline phases are fixed. The curing treatment may be performed simultaneously with the cooling treatment or the heating treatment or performed after the cooling treatment or the heating treatment.

The method of the curing treatment is not particularly limited, and examples thereof include a photocuring treatment and a thermal curing treatment. Particularly, a light irradiation treatment is preferable, and an ultraviolet irradiation treatment is more preferable. For the ultraviolet irradiation, a light source such as an ultraviolet lamp is used.

In the cholesteric liquid crystal layer 38L having a large lenticular structure, which corresponds to the structure having only a liquid crystal layer film including the support 36 and the cholesteric liquid crystal layer 38L just as the reflection member 40 shown in FIG. 10, as described above, the inter-peak distance p in the lenticular structure of the bright portions B and the dark portions D is preferably short, and the amplitude s is preferably large.

Specifically, in the cholesteric liquid crystal layer 38L having a large lenticular structure, the inter-peak distance p in the lenticular structure of the bright portions B and the dark portions D is preferably 0.5 to 30 μm, and more preferably 1 to 15 μm. Furthermore, the amplitude s in the lenticular structure of the bright portions B and the dark portions D is preferably 0.05 to 30 μm, and more preferably 0.1 to 15 μm.

In a case where the cholesteric liquid crystal layer 38L having a large lenticular structure has the lenticular structure described above, it is possible to obtain a reflection member 40 having retroreflection properties and appropriate diffuse reflection properties that are further improved.

The reflection member used in the optical device according to the embodiment of the present invention is obtained by fixing cholesteric liquid crystalline phases selectively reflecting infrared, and has a plurality of regions in which the helical axes of the cholesteric liquid crystalline phases incline in different directions.

In the example described so far, because the reflection member has two-dimensionally arranged dots obtained by fixing cholesteric liquid crystalline phases and/or because the reflection member has a cholesteric liquid crystal layer which is obtained by fixing cholesteric liquid crystalline phases and has a lenticular structure formed of bright portions B and dark portions D resulting from the cholesteric liquid crystalline phases, the reflection member has a plurality of regions in which the helical axes of the cholesteric liquid crystalline phases incline in different directions.

However, the present invention is not limited thereto, and can use various constitutions in which the reflection member is obtained by fixing cholesteric liquid crystalline phases and has a plurality of regions in which the helical axes of the cholesteric liquid crystalline phases incline in different directions.

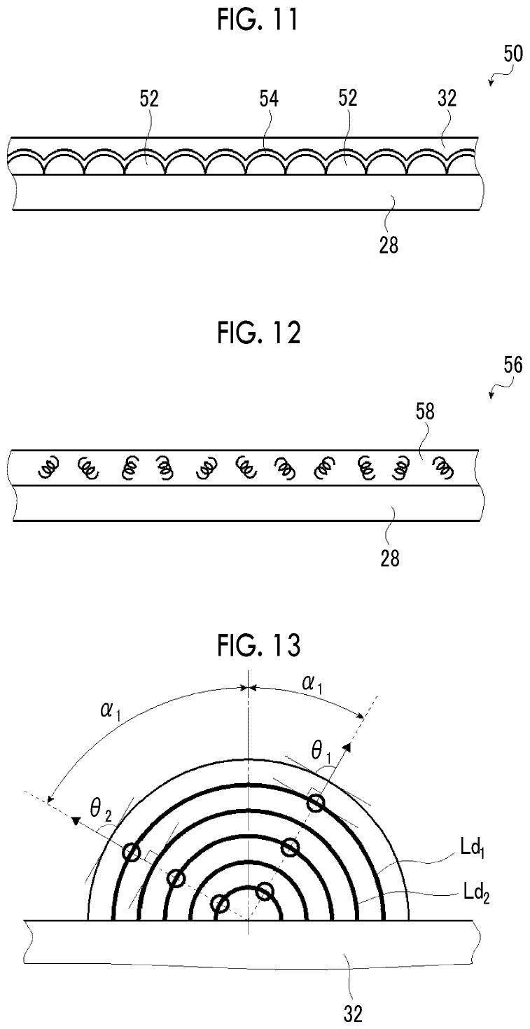

For example, just as a reflection member 50 conceptually shown in FIG. 11, a constitution may be adopted in which transparent projections 52 in the form of a transparent semi-sphere are formed on a surface of the support 28, a cholesteric liquid crystal layer 54 covering the projections 52 is formed by fixing cholesteric liquid crystalline phases, and the overcoat layer 32 covering the cholesteric liquid crystal layer 54 is formed.

In the reflection member 50, the projections 52 may be formed by an ink jet method and the like just as the dots 30 by using a liquid composition containing a transparent resin material, and if necessary, the projections 52 may be formed by being cured by means of ultraviolet irradiation and the like. Alternatively, as a support, a substance such as a glass blasting mat sheet or a microlens array on which the projections 52 are formed may be used.

The cholesteric liquid crystal layer 54 may be formed by preparing a liquid composition containing the liquid crystal compound described above, coating a support with the liquid crystal composition such that the projections 52 are covered, aligning molecules of the liquid crystal compound in a state of cholesteric liquid crystalline phases, and then curing the liquid crystal composition.

As the shape of the projections 52, in addition to the semi-sphere shape (approximately semi-sphere shape), various shapes such as a spherical segment shape (approximately spherical segment shape) exemplified above regarding the dots 30 can be used.

Furthermore, just as reflection member 56 conceptually shown in FIG. 12, it is also possible to use a constitution in which directions of helical axes of helical structures of cholesteric liquid crystalline phases contained in a cholesteric liquid crystal layer 58 are irregular.

The cholesteric liquid crystal layer 58, in which the directions of helical axes of helical structures of the cholesteric liquid crystalline phases are irregular, can be formed by a method of coating the support 28 without anchoring force with the liquid crystal composition described above and forming the cholesteric liquid crystal layer 58 in the same manner as described above, a method of dispersing fine particles obtained by fixing cholesteric liquid crystalline phases, and the like.

In addition, one or more members among the dot film 24, the cholesteric liquid crystal layer 38, and the cholesteric liquid crystal layer 38L may be used in combination with the cholesteric liquid crystal layer 54 and/or the cholesteric liquid crystal layer 58.

Hitherto, the optical device and the laminated film according to the embodiment of the present invention have been specifically described, but the present invention is not limited to the above examples. It goes without saying that within a range that does not depart from the gist of the present invention, the present invention may be ameliorated or modified in various ways.

### EXAMPLES

Hereinafter, the characteristics of the present invention will be more specifically described based on examples. The materials and reagents, the amount thereof used, the amount of substances, ratios, treatment contents, treatment procedures, and the like described in the following examples can be appropriately modified as long as the gist of the present invention is maintained. Accordingly, the scope of the present invention is not limited to the following specific examples.

[Reflection Film 01]

<Preparation of Undercoat Layer Coating Solution>

The following components were stirred and dissolved in a container kept at 25° C., thereby preparing an undercoat layer coating solution 01.

(Undercoat layer coating solution 01)

| | |
|---|---|
| KAYARAD PET30 (manufactured by Nippon | 100 parts by mass |
| Kayaku Co., Ltd.) | |
| IRGACURE 907 (manufactured by Ciba-Geigy | 3 parts by mass |
| AG) | |
| KAYACURE DETX (manufactured by Nippon | 1 part by mass |
| Kayaku Co., Ltd.) | |
| Methyl ethyl ketone | 120 parts by mass |

<Preparation of Support 01 with Undercoat Layer>

As a support, a TAC film (manufactured by FUJIFILM Corporation, TD80UL) having a thickness of 80 μm was prepared.

A surface of the support was coated with the undercoat layer coating solution 01 by using a #3.6 bar coater. Then, the coating solution was dried for 60 seconds at 95° C. and irradiated with ultraviolet at 500 mJ/cm² in an environment with 25° C. by using an ultraviolet irradiation device, thereby preparing a support 01 with an undercoat layer.

<Preparation of Coating Solution IRm1 for Cholesteric Liquid Crystal Layer>

The following components were stirred and dissolved in a container kept at 25° C., thereby preparing a coating solution IRm1 for a cholesteric liquid crystal layer.

(Coating solution IRm1 for a cholesteric liquid crystal layer)

| | |
|---|---|
| The following mixture A of rod-like liquid | 100 parts by mass |
| crystal compound | |
| IRGACURE 907 (manufactured by BASF SE) | 3 parts by mass |
| KAYACURE DETX (manufactured by | 1 part by mass |
| Nippon Kayaku Co., Ltd.) | |
| The following chiral agent A | 3.31 parts by mass |
| The following surfactant F1 | 0.08 parts by mass |
| Methyl ethyl ketone | 250 parts by mass |

Mixture a of Rod-Like Liquid Crystal Compounds

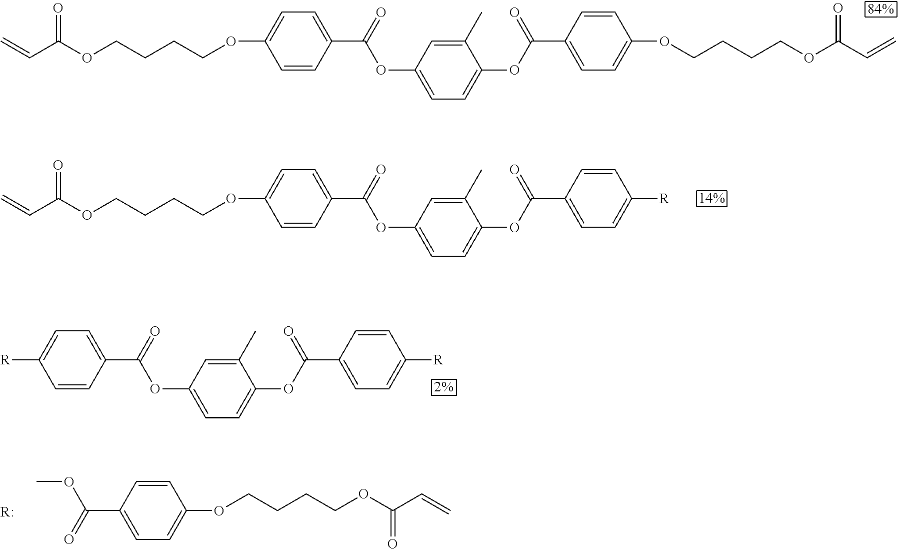

Chiral Agent A

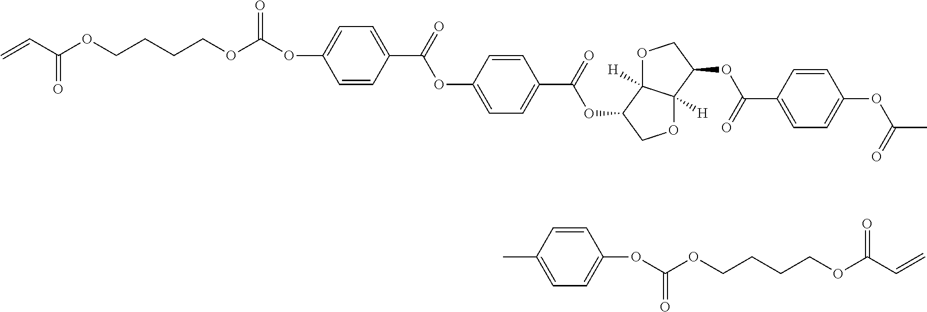

Surfactant F1

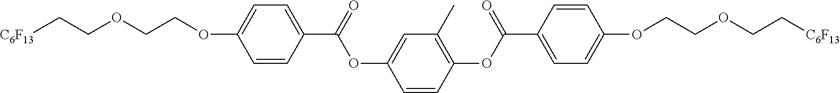

The coating solution IRm1 for a cholesteric liquid crystal layer is a material forming cholesteric liquid crystalline phases reflecting light at a central wavelength of selective reflection of 900 nm. Furthermore, the coating solution IRm1 for a cholesteric liquid crystal layer is a material forming cholesteric liquid crystalline phases reflecting right circular polarization.

<Formation of Cholesteric Liquid Crystal Layer (Preparation of Reflection Member 01)>

The undercoat layer of the support 01 with an undercoat layer was coated with the coating solution IRm1 for a cholesteric liquid crystal layer by using a #12 bar coater. Then, the coating solution was dried for 60 seconds at 95° C. and then irradiated with ultraviolet at 500 mJ/cm² in an environment with 25° C. by using an ultraviolet irradiation device.

In this way, a reflection member 01 having a cholesteric liquid crystal layer obtained by fixing cholesteric liquid crystalline phases was prepared.

A cross section was cut from the reflection member 01 by using an ultramicrotome, pretreated appropriately, and observed with SEM (manufactured by Hitachi High-Technologies Corporation, SU8030).

As a result, as being conceptually shown in FIG. 2 and FIG. 6, the cholesteric liquid crystal layer of the reflection member 01 was found to have a streak pattern formed of dark portions and bright portions and have a lenticular structure in which a plurality of peaks and valleys having an angle of inclination of 0° with respect to the formation surface were checked in a continuous line formed of the bright portions or the dark portions. Furthermore, as being conceptually shown in FIG. 7, the average of the inter-peak distance p in the lenticular structure of the bright portions and the dark portions was 12 μm, and the average of the amplitude s was 1.2 μm.

In addition, in the cholesteric liquid crystal layer of the reflection member 01, an angle formed between the continuous line, which was formed by the bright portions or the dark portions interposed between the adjacent peak and valley, and the formation surface was equal to or greater than 5° substantially in all regions.

[Reflection Film 02]

<Preparation of Undercoat Layer Coating Solution>

The following components were stirred and dissolved in a container kept at 25° C., thereby preparing an undercoat layer coating solution 02.

(Undercoat layer coating solution 02)

| | |
|---|---|
| Viscoat #160 (manufactured by OSAKA | 100 parts by mass |
| ORGANIC CHEMICAL INDUSTRY LTD) | |
| The following surfactant A | 0.6 parts by mass |
| IRGACURE 907 (manufactured by BASF SE) | 3 parts by mass |
| Methyl ethyl ketone | 900 parts by mass |

Surfactant A

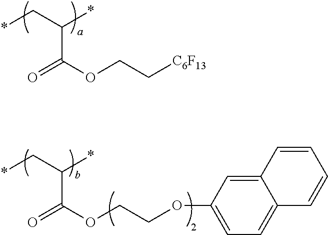

In the formula, a represents 36.5 and b represents 63.5, which show that the polymers are randomly copolymerized at the mass ratio represented by a and b.

<Preparation of Support 02 with Undercoat Layer>

As a support, a TAC film (manufactured by FUJIFILM Corporation, TD80UL) having a thickness of 80 μm was prepared.

A surface of the support was coated with the undercoat layer coating solution 02 by using a #2.6 bar coater. Then, the coating solution was dried by heating for 60 seconds such that the temperature of the film surface became 50° C. Thereafter, the coating solution was irradiated with ultraviolet at 500 mJ/cm² by using an ultraviolet irradiation device, thereby preparing a support 02 with an undercoat layer.

<Preparation of Coating Solution IRm2 for a Cholesteric Dots>

A coating solution IRm2 for cholesteric dots was prepared in the same manner as used for preparing the coating solution IRm1 for a cholesteric liquid crystal layer, except that the amount of the chiral agent A in the coating solution IRm1 for a cholesteric liquid crystal layer was changed to 3.44 parts by mass.

The coating solution IRm2 for cholesteric dots is a material forming cholesteric liquid crystalline phases reflecting light at a central wavelength of selective reflection of 850 nm. Furthermore, the coating solution IRm2 for cholesteric dots is a material forming cholesteric liquid crystalline phases reflecting right circular polarization.

<Formation of Dots>

By using an ink jet printer (manufactured by FUJIFILM Dimatix, Inc., DMP-2831), the prepared coating solution IRm2 for cholesteric dots was jetted to the entire 200×150 mm region of the undercoat layer of the support 02 with an undercoat layer such that a center-to-center distance (pitch) between dots became 50 μm.

Then, the coating solution was dried for 30 seconds at 60° C. and irradiated with ultraviolet at 500 mJ/cm² by using an ultraviolet irradiation device at room temperature such that the coating solution was cured, thereby two-dimensionally forming dots obtained by fixing cholesteric liquid crystalline phases on the surface of the support 02 with an undercoat layer.

Ten dots were randomly selected from the prepared dots, and the shapes of the dots were observed with a laser microscope (manufactured by KEYENCE CORPORATION). As a result, the average diameter of the dots was 30 μm, and the average maximum height of the dots was 6 μm. Furthermore, at the edge of each of the dots, the surface of each of the dots and the surface of the undercoat layer formed an angle (contact angle) of 40° on average in a portion where the dot surface and the surface of the undercoat layer contacted. In addition, the height of each of the dots increases toward the center from the edge of the dot.

One right circular polarization-reflecting dot 34R positioned at the center of the support 28 was cut in a direction perpendicular to the support 28 within the surface including the center of the dot, and the cross section was observed with SEM. As a result, a streak pattern of bright portions and dark portions shown in FIG. 3 and FIG. 4 was checked on the inside of the dot.

Furthermore, from the cross-sectional view, as shown in FIG. 3, at a position where an angle α1 with respect to a line (dashed line), which passed the center of the dot and was perpendicular to the surface of the support 28, is 30° and at a position where an angle α1 with respect to the same line is 60°, angles θ₁ and θ₂ formed between the normal direction of a line formed by the dark portions of the dot and the surface of the dot were measured. As being conceptually shown in FIG. 13, θ₁ and θ₂ were measured for three lines formed by the dark portions, including a line formed by the outermost dark portion of the dot (line Ld₁ (edge of the dot) formed by the first dark portion in FIG. 3), a line formed by the innermost dark portion of the dot (center of the dot), and a line (between the edge of the dot and the center) formed by the dark portion between the edge of the dot and the center of the dot.

As a result, θ₁ and θ₂ were 90° at the edge of the dot, 89° between the edge of the dot and the center, and 90° at the center of the dot. That is, in the dots, the angle formed between the normal direction of the line formed by the dark portions of the dot and the surface of the dot was substantially the same among the position around the surface of the dot, the center (innermost portion) of the dot, and the central portion of the dot.

<Preparation of Coating Solution 1 for Overcoat Layer>

The following components were stirred and dissolved in a container kept at 25° C., thereby preparing a coating solution for an overcoat.

(Coating solution 1 for overcoat layer)

| | |
|---|---|
| Methyl ethyl ketone | 103.6 part by mass |
| KAYARAD DPCA-30 (manufactured by | 30 parts by mass |
| Nippon Kayaku Co., Ltd.) | |
| EA-200 (manufactured by Osaka Gas | 25 parts by mass |
| Chemicals Co., Ltd.) | |
| The following compound L | 45 parts by mass |
| Surfactant A described above | 0.6 parts by mass |
| IRGACURE 127 (manufactured by BASF SE) | 3 parts by mass |

Compound L

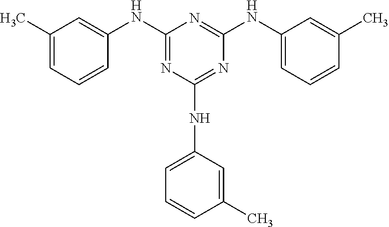

<Formation of Overcoat Layer 1>

By using a #12 bar coater, the support 02 with an undercoat layer on which dots were formed was coated with the prepared coating solution 1 for an overcoat.

Then, the coating film was dried by being heated for 60 seconds such that the temperature of the coating film surface became 50° C., and then irradiated with ultraviolet at 500 mJ/cm² by using an ultraviolet irradiation device with nitrogen purging at an oxygen concentration equal to or lower than 100 ppm such that a crosslinking reaction occurred, thereby preparing an overcoat layer 1.

<Preparation of Coating Solution 2 for Overcoat Layer>

The following components were stirred and dissolved in a container kept at 25° C., thereby preparing a coating solution 2 for an overcoat.

(Coating solution 2 for overcoat)

| | |
|---|---|
| Methyl ethyl ketone | 103.6 parts by mass |
| KAYARAD DPHA (manufactured by Nippon | 30 parts by mass |
| Kayaku Co., Ltd.) | |
| The surfactant A described above | 0.6 parts by mass |
| IRGACURE 127 (manufactured by BASF SE) | 3 parts by mass |

<Formation of Overcoat Layer 2 (Preparation of Reflection Member 02)>

By using a #2 bar coater, the overcoat layer 1 was coated with the coating solution 2 for an overcoat.

Then, the coating film was dried by being heated for 60 seconds such that the temperature of the film surface became 50° C., and then irradiated with ultraviolet at 500 mJ/cm² at 60° C. by using an ultraviolet irradiation device with nitrogen purging at an oxygen concentration equal to or lower than 100 ppm such that a crosslinking reaction occurred, thereby obtaining an overcoat layer 2. In this way, a reflection member 02 was obtained.

[Reflection Member 03]

The side of the cholesteric liquid crystal layer of the reflection member 01 was laminated on the side of the support of the reflection member 02 by being bonded through a pressure sensitive adhesive (manufactured by Soken Chemical & Engineering Co., Ltd., SK pressure sensitive adhesive).

The obtained laminate was named reflection member 03.

[Reflection Member 04]

<Preparation of TAC Film 01 with Alignment Film>

By using a #16 wire bar coater, a surface of a TAC film (manufactured by FUJIFILM Corporation, TD80UL) was coated with an alignment film coating solution composed as below at 28 mL/m². Then, the coating film was dried for 60 seconds with hot air of 60° C. and then for 150 seconds with hot air of 90° C.

On the surface of the formed film, by using a rubbing roll, a rubbing treatment was performed in a direction parallel to a transport direction at 1,000 rpm, thereby preparing a TAC film 01 with an alignment film.

(Alignment film coating solution)

| | |
|---|---|
| The following modified | 10 parts by mass |
| polyvinyl alcohol | |
| Water | 370 parts by mass |
| Methanol | 120 parts by mass |
| Glutaraldehyde | 0.5 parts by mass |
| (crosslinking agent) | |

Modified Polyvinyl Alcohol

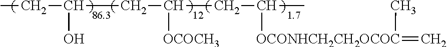

<Preparation of Reflection Member 04>

By using a #12 bar coater, the prepared TAC film 01 with an alignment film was coated with the coating solution IRm1 for a cholesteric liquid crystal layer. Then, the coating film was dried for 60 seconds at 95° C. and irradiated with ultraviolet at 500 mJ/cm² in an environment of 25° C. by using an ultraviolet irradiation device.

In this way, a reflection member 04 was prepared which had a cholesteric liquid crystal layer obtained by fixing cholesteric liquid crystalline phases.

Just as the reflection member 01, the cross section of the reflection member 04 was observed. As a result, in the cross section of the cholesteric liquid crystal layer of the reflection member 04, as being conceptually shown in FIG. 5, a streak pattern was checked which was parallel to the surface of the TAC film 01 with an alignment film and constituted with dark portions and bright portions that were flat without rise and fall (horizontal structure).

[Evaluation]

Each of the prepared reflection member 01 (Example 1), reflection member 02 (Example 2), and reflection member 03 (Example 3), white copy paper as a reflection member (Comparative Example 2), and the prepared reflection member 04 (Comparative Example 3) was bonded to a glass plate (manufactured by Corning Incorporated, EAGLE glass) by using a pressure sensitive adhesive (manufactured by Soken Chemical & Engineering Co., Ltd., SK pressure sensitive adhesive). Furthermore, the glass plate was used as Comparative Example 1.

As a light source and an infrared camera, those included in a motion capture device (Kinect v1, manufactured by Microsoft) were used.

Each of the reflection members bonded to glass and the glass plate was separated from the motion capture device by a distance of 80 cm and disposed at a location 30 cm distant from the center of the motion capture device in a lateral direction. This operation was repeated 100 times, and the number of times the reflection member was detected was counted. The results are as below.

| | |
|---|---|
| Comparative Example 1: glass only | not detected |
| Example 1: reflection member 01 (lenticular structure) | detected 35 times |
| Example 2: reflection member 02 (dots) | detected 15 times |
| Example 3: reflection member 03 (laminate of 01 and | detected 76 times |
| 02) | |
| Comparative Example 2: white copy paper | detected 100 times |
| Comparative Example 3: reflection member 04 | not detected |
| (horizontal structure) | |

Furthermore, even though the distance between the motion capture device and each of the reflection members was changed to 40 cm and 100 cm, and the reflection members were detected in the same manner as described above, the ranking did not change. From this result, it was confirmed that a transparent reflection member can also be used in an infrared range finder.

As will be described later, the reflection member used in the present invention has transparency comparable to that of glass.

The optical device according to the embodiment of the present invention and general motion capture devices radiate infrared from a light source, check whether an object is present between the light source and a reflection member by detecting retroreflected light and diffuse reflected light by using infrared cameras, and measures the distance based on a difference (parallax) between a left detection location and a right detection location.

In a case where a reflection member that performs only regular reflection just as glass is used, infrared is not reflected toward the infrared camera. Accordingly, Comparative Example 1, that is, the glass plate, and Comparative Example 3, that is, the reflection member 04, in which the bright portions and the dark portions in a cross section thereof form a horizontal structure, are never detected while they are being measured 100 times in the test described above. In other words, in a case where a reflection member that performs only regular reflection just as glass is used, although the transparency that makes it possible to see the opposite side of the reflection member can be secured, because the reflection member does not perform retroreflection and diffuse reflection, an object present between the light source and the reflection member cannot be detected.

In contrast, the reflection member used in the present invention has transparency comparable to that of glass and is detected again and again in the test described above.

This result shows that the reflection member used in the present invention has retroreflection properties and diffuse reflection properties. That is, the result shows that in a case where the optical device according to the embodiment of the present invention using the reflection member radiates infrared from a light source and detects retroreflected light and diffuse reflected light by using infrared cameras, it is possible to detect an object present between the light source and the reflection member while securing transparence that makes it possible to see the opposite side of the reflection member.

Furthermore, the larger the number of times a reflection member detected by the aforementioned test, the better the retroreflection properties and diffuse reflection properties of the reflection member. Accordingly in a case where a reflection member which is detected many times by the test described above is used, an object present between the light source and the reflection member is more accurately detected.

In order to confirm the above results, each of the reflection members of Examples 1 to 3 and Comparative Examples 1 to 3 was fixed at a position 80 cm distant from the motion capture device, a hand popped in and out of a position 10 cm above the reflection member 100 times, and number of times the hand was detected was counted. The results are as below.

| | |
|---|---|
| Comparative Example 1: glass only | not detected |
| Example 1: reflection member 01 (lenticular structure) | detected 32 times |
| Example 2: reflection member 02 (dots) | detected 18 times |
| Example 3: reflection member 03 (laminate of 01 and | detected 78 times |
| 02) | |
| Comparative Example 2: white copy paper | detected 100 times |
| Comparative Example 3: reflection member 04 | not detected |
| (horizontal structure) | |

From the above results, it was confirmed that according to the present invention, it is possible to detect an object present between a light source and a reflection member while securing transparency that makes it possible to see the opposite side of the reflection member as described below.

For the glass and the reflection members used in comparative examples and the reflection members used in examples, a haze and a total light transmittance were measured so as to check whether the transparency of the reflection members used in examples are comparable to that of glass.

For the measurement, a hazemeter NDH-2000 manufactured by NIPPON DENSHOKU INDUSTRIES Co., LTD was used. The results are as below.

| | |
|---|---|
| Comparative Example 1: | haze: 0.2%, total light |
| glass only | transmittance: 92% |
| Example 1: reflection | haze: 1.8%, total light |
| member 01 | transmittance: 90% |
| (lenticular structure) | |
| Example 2: reflection | haze: 2.4%, total light |
| member 02 (dots) | transmittance: 90% |
| Example 3: reflection | haze: 4.0%, total light |
| member 03 (laminate | transmittance: 88% |
| of 01 and 02) | |
| Comparative Example 2: | haze: 99.9%, total light |
| white copy paper | transmittance: 0.2% |
| Comparative Example 3: | haze: 0.5%, total light |
| reflection member 04 | transmittance: 91% |
| (horizontal structure) | |

The above results clearly show the effects of the present invention.

The present invention can be suitably used as a motion capture device.

### EXPLANATION OF REFERENCES

10: optical device
12: base
14: light source
16: infrared camera
20, 40, 50, 56: reflection member
24: dot film
26: liquid crystal layer film
28, 36: support
30: dot
32: overcoat layer
36a: formation surface
38, 38L, 54, 58: cholesteric liquid crystal layer
54: dot
100: layer
B: bright portion
D: dark portion
N: normal line
S: direction

What is claimed is:

1. An optical device comprising:
a light source radiating infrared;
an infrared sensor detecting infrared; and
a reflection member selectively reflecting infrared,
wherein the infrared radiated from the light source is reflected from the reflection member,
the infrared reflected from the reflection member is detected by the infrared sensor,
the reflection member has a cholesteric liquid crystal layer,
the cholesteric liquid crystal layer is a layer obtained by fixing cholesteric liquid crystalline phases formed on a planar formation surface, and
in a cross-sectional view of the cholesteric liquid crystal layer observed with a scanning electron microscope, bright portions and dark portions resulting from the cholesteric liquid crystalline phases have a lenticular structure.

2. The optical device according to claim 1,
wherein the reflection member further has a dot array, and
the dot array is obtained by two-dimensionally arranging dots formed by fixing the cholesteric liquid crystalline phases on a planar formation surface.

3. The optical device according to claim 1,
wherein the reflection member has the cholesteric liquid crystal layer, and
an average inter-peak distance in the lenticular structure of the bright portions and the dark portions resulting from the cholesteric liquid crystalline phases of the cholesteric liquid crystal layer is 1 to 50 μm.

4. The optical device according to claim 1,
wherein a haze of the reflection member is equal to or lower than 10%.

5. A laminated film comprising:
a dot array; and
a cholesteric liquid crystal layer,
wherein the dot array is obtained by two-dimensionally arranging dots obtained by fixing cholesteric liquid crystalline phases on a planar formation surface,
the cholesteric liquid crystal layer is a layer obtained by fixing cholesteric liquid crystalline phases on a planar formation surface, and
in a cross-sectional view of the cholesteric liquid crystal layer observed with a scanning electron microscope, bright portions and dark portions resulting from the cholesteric liquid crystalline phases have a lenticular structure.
